(19) United States
(12) Patent Application Publication
(10) Pub. No.: US 2010/0080594 A1
(43) Pub. Date: Apr. 1, 2010

(54) Image Forming Apparatus and Image Forming Method

(75) Inventors: Takeshi SOWA, Matsumoto-shi (JP); Yujiro NOMURA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/567,495

(22) Filed: Sep. 25, 2009

(30) Foreign Application Priority Data
Sep. 29, 2008 (JP) 2008-250622

(51) Int. Cl. G03G 15/043

(52) U.S. Cl. 399/51

(57) ABSTRACT

An image forming apparatus includes: a latent image carrier; and an exposure head having light-emitting elements configured to emit light beams and form beam spots on the latent image carrier and image forming optical systems configured to form images of light beams emitted from the light-emitting elements arranged in a first direction and form group of beam spots on the latent image carrier, wherein the different image forming optical systems form the group of beam spots in an overlapped manner in the first direction, and the light-emitting elements include the light-emitting elements which define a first spot center distance Dsp_{—}1 in the first direction and the light-emitting elements which define a second spot center distance Dsp_{—}2 different from the first spot center distance in the first direction.

### CROSS-REFERENCE TO RELATED APPLICATIONS

This application claims the benefit of priority under 35 USC 119 of Japanese application no. 2008-250622, filed on Sep. 29, 2008, which is incorporated herein by reference.

### BACKGROUND

1. Technical Field

The present invention relates to an image forming apparatus configured to expose a latent image carrier by an exposure head which forms an image of light from a light-emitting element and an image forming method.

2. Related Art

In the related art, a printer head (exposure head) which exposes a surface (exposed surface, image surface) of a latent image carrier by light formed into an image by a plurality of lenses arranged in a primary scanning direction is proposed (JP-A-2000-158705). With this printer head, the respective lenses are able to expose areas different from each other in the primary scanning direction. In other words, each lens has a light-emitting element array including a plurality of light-emitting elements. Each lens is able to form an image with light from the light-emitting elements and form a plurality of spots arranged in its exposed area in the primary scanning direction. Then, the printer head forms spots at positions corresponding to a latent image to be formed, so that the latent image is formed on the latent image carrier.

As described later, the exposure head may be configured so that the exposed areas of different image forming optical systems (lenses) are overlapped in the primary scanning direction. In this configuration, the distance between spots in the primary scanning direction is an important factor in order to form a satisfactory latent image.

### SUMMARY

An advantage of some aspects of the invention is to provide a technology which achieves formation of a satisfactory latent image in a configuration in which exposing areas of different image forming optical systems are overlapped with each other.

According to a first aspect of the invention, there is provided an image forming apparatus including: a latent image carrier, and an exposure head having light-emitting elements configured to emit light beams and form beam spots on the latent image carrier and image forming optical systems configured to form images of the light beams emitted from the light-emitting elements arranged in a first direction and form group of beam spots on the latent image carrier, in which the different image forming optical systems form the group of beam spots in an overlapped manner in the first direction, and the light-emitting elements include the light-emitting elements which define a first spot center distance Dsp_1 in the first direction and the light-emitting elements which define a second spot center distance Dsp_2 different from the first spot center distance in the first direction.

According to a second aspect of the invention, there is provided an image forming method including: forming a latent image on a latent image carrier by an exposure head having light-emitting elements configured to emit light beams and form beam spots on the latent image carrier and image forming optical systems configured to form images of the light beams emitted from the light-emitting elements arranged in a first direction and form group of beam spots on the latent image carrier, in which the different image forming optical systems form the group of beam spots in an overlapped manner in the first direction, and the light-emitting elements include the light-emitting elements which are arranged at a first spot center distance Dsp_1 in the first direction of the group of beam spots and the light-emitting elements which are arranged at a second spot center distance Dsp_2 different from the first spot center distance in the first direction of the group of beam spots.

In aspects of the invention configured as described above (the image forming apparatus and the image forming method), the image forming optical systems form the group of beam spots on the latent image carrier. Also, the different image forming optical systems form the group of beam spots in an overlapped manner in the first direction, that is, form an overlapped exposed area. Then, the light-emitting elements forming the spots at the first spot center distance Dsp_1 in the first direction and the light-emitting elements forming the spots at the second spot center distance Dsp_2 differs from the first spot center distance in the first direction are included. In other words, according to the aspects of the invention, the image forming optical systems are able to form beam spots at different beam spot center distances. In this manner, the realization of the satisfactory latent image is achieved.

Preferably, the light-emitting elements formed at the first spot center distance Dsp_1 are formed at a first end portion in the first direction of the group of beam spots, and the light-emitting elements formed at the second spot center distance Dsp_2 are formed at a second end portion on the opposite side in the first direction of the group of beam spots. In other words, in the overlapped exposed area, the first end portion of the group of beam spot formed by one of the image forming optical systems and the second end portion of the group of beam spot formed by another image forming optical system are overlapped with each other. Then, in the first end portion, the beam spots are formed at the first spot center distance Dsp_1, and in the second end portion, the beam spots are formed at the second spot center distance Dsp_2. Therefore, in the overlapped exposed area, the beam spots formed at the different beam spot center distances are overlapped with each other. Accordingly, the realization of the satisfactory latent image is achieved.

Preferably, a control unit configured to select the light-emitting elements so that the light-emitting elements are turned on according to image signals to form the beam spots on the latent image carrier. In the configuration in which the control unit is configured to select the light-emitting elements as described above, the distance between the beam spots formed by the different image forming optical systems can be adjusted, so that a satisfactory latent image is formed.

Preferably, the first spot center distance Dsp_1 and the second spot center distance Dsp_2 satisfy one of the relations:

1.0×Dsp_{—}2<Dsp_{—}1<1.5×Dsp_{—}2 and

0.5×Dsp_{—}2<Dsp_{—}1<1.5×Dsp_{—}2.

In this configuration, the difference between the distance between the beam spots formed by the different image forming optical systems and the first spot center distance Dsp_1 becomes to a level smaller than ½ of the first spot center distance Dsp_1, so that a more satisfactory latent image is formed.

Preferably, the first spot center distance Dsp_1 and the second spot center distance Dsp_2 satisfy one of the relations:

1.0×Dsp_{—}2<Dsp_{—}1<1.25×Dsp_{—}2 and

0.75×Dsp_{—}2<Dsp_{—}1<1.0×Dsp_{—}2.

In this configuration, the difference between the distance between the beam spots formed by the different image forming optical systems and the first spot center distance Dsp_1 becomes to a level smaller than ¼ of the first spot center distance Dsp_1, so that a more satisfactory latent image is formed.

Preferably, the image forming optical systems may be arranged in the second direction. This is because the invention is suitably applied for the configuration in which the image forming optical systems are arranged in the second direction described later.

### BRIEF DESCRIPTION OF THE DRAWINGS

The invention will be described with reference to the accompanying drawings, wherein like numbers reference like elements.

FIG. 1 is a drawing showing an example of an image forming apparatus having a line head.

FIG. 2 is a diagram showing an electric configuration of the image forming apparatus in FIG. 1.

FIG. 3 is a perspective view schematically showing the line head.

FIG. 4 is a cross-sectional view of the line head taken along the line A-A in FIG. 3.

FIG. 5 is a drawing showing a structure of light-emitting elements.

FIG. 6 is a plan view showing a configuration of a back surface of a head substrate.

FIG. 7 is a plan view showing a configuration of a lens array.

FIG. 8 is a longitudinal cross-sectional view showing the lens arrays and the head substrate.

FIG. 9 is a drawing showing a light-emitting element group and a spot forming action of the light-emitting element group.

FIG. 10 is an explanatory drawing of a spot center.

FIG. 11 is a spot group formed by simultaneous light emission from the respective light-emitting element groups.

FIG. 12 is a drawing showing a latent image forming action by the line head.

FIG. 13 is a plan view showing a scene where gaps are generated by a skew.

FIG. 14 is a plan view showing a plurality of the spot groups formed in this embodiment.

FIG. 15 is a plan view showing a configuration of the light-emitting element group in this embodiment.

FIG. 16 is a plan view showing the spot group formed by the light-emitting element group.

FIG. 17 is an enlarged plan view showing a portion in the vicinity of an overlapped area of the spot groups.

FIG. 18 is a chart showing the spots used in the latent image forming action.

FIG. 19 is a chart showing the spots used in the latent image forming action.

FIG. 20 is a schematic partial perspective view of a lens array according to another embodiment.

FIG. 21 is a longitudinal partial cross-sectional view of the lens array according to the another embodiment.

FIG. 22 is a plan view of the lens array according to the another embodiment.

FIG. 23 is a drawing showing lens data of still another embodiment.

FIG. 24 is a drawing showing optical data of the still another embodiment.

FIG. 25 is a cross-sectional view of an optical system in a primary scanning direction according to the still another embodiment.

FIG. 26 is a cross-sectional view of the optical system in a secondary scanning direction according to the still another embodiment.

### DESCRIPTION OF EXEMPLARY EMBODIMENTS

In the following description, firstly, a basic configuration of a line head as an exposure head and an image forming apparatus provided with the line head will be described. Then, following to the description of the basic structure, the description of embodiments of the invention will be made.

### Basic Configuration

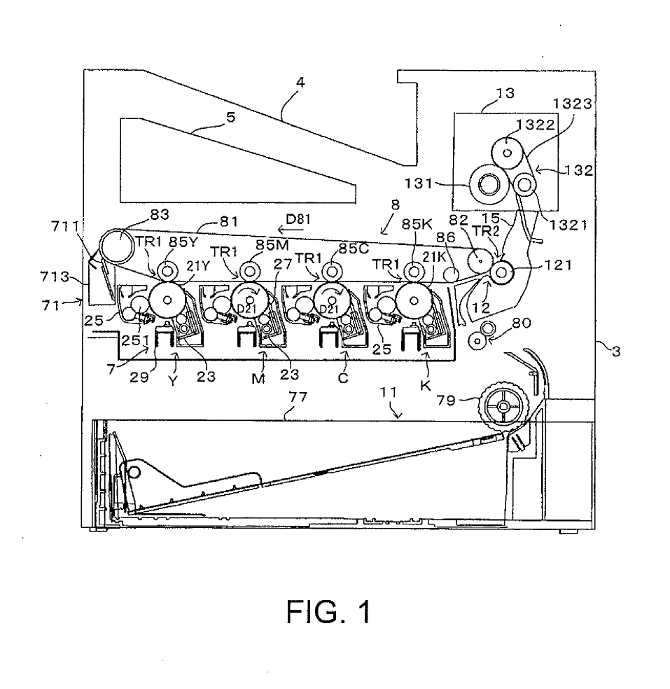

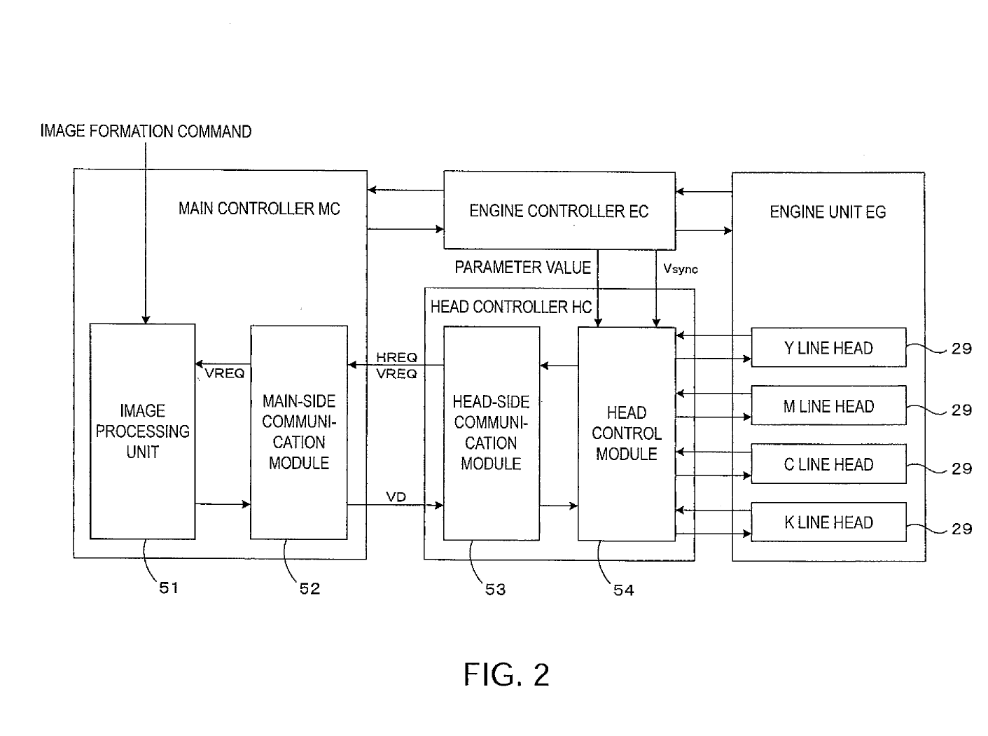

FIG. 1 is a drawing showing an example of an image forming apparatus having a line head. FIG. 2 is a diagram showing an electric configuration of the image forming apparatus in FIG. 1. This apparatus is an image forming apparatus which is able to be selectively operated in a color mode in which four colors of toner of black (K), cyan (C), magenta (M) and yellow (Y) are overlapped to form a color image and a monochrome mode in which only black (K) toner is used to form a monochrome image. FIG. 1 is a drawing corresponding to a case of being operated in the color mode. In this image forming apparatus, when an image formation command is given from an external apparatus such as a host computer to a main controller MC having a CPU or a memory, the main controller MC issues control signals to an engine controller EC and a video data VD corresponding to the image formation command to a head controller HC. The head controller HC controls line heads 29 in respective colors on the basis of the video data VD from the main controller MC and a vertical synchronous signal Vsync and a parameter value from the engine controller EC. Accordingly, an engine unit EG performs a predetermined image forming action, and forms an image corresponding to the image formation command on a sheet such as copying paper, transfer paper, form, or OHP transparent sheet.

Provided in a housing body 3 of the image forming apparatus is an electrical box 5 having a power source circuit board, the main controller MC, the engine controller EC, and the head controller HC integrated therein. An image forming unit 7, a transfer belt unit 8, and a paper feeding unit 11 are also disposed in the housing body 3. A secondary transfer unit 12, a fixing unit 13, and a sheet guiding member 15 are disposed on the right side in the housing body 3 in FIG. 1. The paper feeding unit 11 is demountably mounted on an apparatus body 1. The paper feeding unit 11 and the transfer belt unit 8 are configured to be demountable for repair or replacement.

The image forming unit 7 includes four image forming stations Y (for yellow), M (for magenta), C (for cyan), and K (for black) which form a plurality of images in different colors. The respective image forming stations Y, M, C, and K each have a cylindrical photoconductor drum 21 having a surface extending in a primary scanning direction MD by a predetermined length. Then, the respective image forming stations Y, M, C, and K each form a toner image of a corresponding color on the surface of the photoconductor drum 21. The photoconductor drums are each arranged in such a manner that the axial direction thereof extends in parallel or are substantially parallel to the primary scanning direction MD. The each photoconductor drum 21 is connected to a drive motor specific thereto, and is driven to rotate at a predetermined velocity in the direction indicated by an arrow D21 in the drawing. Accordingly, the surface of the photoconductor drum 21 is transported in a secondary scanning direction SD which is orthogonal or substantially orthogonal to the primary scanning direction MD. A charging unit 23, a line head 29, a developing unit 25, and a photoconductor cleaner 27 are disposed on the periphery of the each photoconductor drum 21 along the direction of rotation thereof. Then, a charging action, a latent image forming action, and a toner developing action are performed by these functional units. Therefore, when the image forming apparatus is operated in the color mode, the toner images formed by all these image forming stations Y, M, C, and K are overlapped on a transfer belt 81 included in the transfer belt unit 8 to form a color image, while when the image forming apparatus is operated in the monochrome mode, a toner image formed only by the image forming station K is used to form a monochrome image. In FIG. 1, since the respective image forming stations of the image forming unit 7 have the same configuration, only part of the image forming stations are designated by reference numerals and reference numerals are omitted for other image forming stations for the sake of convenience of graphical representation.

The charging unit 23 includes a charging roller whose surface is formed of an elastic rubber. The charging roller is configured to be driven in abutment with the surface of the photoconductor drum 21 at a charging position, and is rotated in association with the rotation of the photoconductor drum 21 at a peripheral velocity in the driven direction with respect to the photoconductor drum 21. The charging roller is connected to a charging bias generating unit (not shown) so as to charge the surface of the photoconductor drum 21 at the charging position where the charging unit 23 and the photoconductor drum 21 come into abutment with each other upon reception of delivery of the charging bias from the charging bias generating unit.

The line head 29 is arranged apart from the photoconductor drum 21, and the longitudinal direction of the line head 29 extends in parallel or substantially parallel to the primary scanning direction MD and the widthwise direction of the line head 29 extends in parallel or substantially parallel to the secondary scanning direction SD. The line head 29 includes a plurality of light-emitting elements arranged in the longitudinal direction. The light-emitting elements emit light beams according to the video data VD from the head controller HC. Then, when the surface of the charged photoconductor drum 21 is irradiated with light beams from the light-emitting elements, an electrostatic latent image is formed on the surface of the photoconductor drum 21.

The developing unit 25 includes a developing roller 251 having toner on a surface thereof. Then, by a developing bias applied from a developing bias generating unit (not shown) electrically connected to the developing roller 251 to the developing roller 251, the charged toner is transferred from the developing roller 251 to the photoconductor drum 21 at a developing position where the developing roller 251 and the photoconductor drum 21 come into abutment with each other, and the formed electrostatic latent image is visualized by the line head 29.

The toner image visualized by the above-described developing position is transported in the rotating direction D21 of the photoconductor drum 21 and is primarily transferred to the transfer belt 81 at a primary transfer position TR1 where the transfer belt 81 and the respective photoconductor drums 21 come into abutment with each other.

In this embodiment, the photoconductor cleaner 27 is provided on the downstream side of the primary transfer position TR1 in terms of the rotating direction D21 of the photoconductor drum 21 and on the upstream side of the charging unit 23 so at to be in abutment with the surface of the photoconductor drum 21. The photoconductor cleaner 27 comes into abutment with the surface of the photoconductor drum to remove the toner remaining on the surface of the photoconductor drum 21 after the primary transfer by cleaning.

The transfer belt unit 8 includes a drive roller 82, a driven roller 83 (blade-opposed roller) disposed on the left side of the drive roller 82 in FIG. 1, and the transfer belt 81 wound around these rollers and driven to circulate in the direction indicated by an arrow D81 (transporting direction). The transfer belt unit 8 includes four primary transfer rollers 85Y, 85M, 85C, and 85K arranged inside the transfer belt 81 so as to oppose the respective photoconductor drums 21 in the respective image forming stations Y, M, C, and K in one-to-one correspondence therewith when the photoconductor cartridge is mounted. The primary transfer rollers 85 each are electrically connected to a primary transfer bias generating unit (not shown). When being operated in the color mode, all these primary transfer rollers 85Y, 85M, 85C, and 85K are positioned on the side of the image forming stations Y, M, C, and K as shown in FIG. 1, so that the transfer belt 81 is pressed into abutment with the respective photoconductor drums 21 of the image forming stations Y, M, C, and K thereby forming the primary transfer positions TR1 between the respective photoconductor drums 21 and the transfer belt 81. Then, a primary transfer bias is applied to the primary transfer rollers 85 from the primary transfer bias generating unit at adequate timing, so that the toner images formed on the surfaces of the respective photoconductor drums 21 are transferred to the surface of the transfer belt 81 at the corresponding primary transfer positions TR1, thereby forming a color image.

In contrast, when being operated in the monochrome mode, the color primary transfer rollers 85Y, 85M, and 85C from among four primary transfer rollers 85 are moved apart from the respective image forming stations Y, M, and C opposing thereto and only the monochrome primary transfer roller 85K is brought into abutment with the image forming station K, so that only the monochrome image forming; station K is brought into abutment with the transfer belt 81. Consequently, the primary transfer position TR1 is formed only between the monochrome primary transfer roller 85K and the image forming station K. Then, a primary transfer bias is applied to the monochrome primary transfer roller 85K from the primary transfer bias generating unit at adequate timing, so that the toner images formed on the surface of the photoconductor drum 21 are transferred to the surface of the transfer belt 81 at the primary transfer position TR1, thereby forming a monochrome image.

In addition, the transfer belt unit 8 includes a downstream guide roller 86 provided on the downstream side of the monochrome primary transfer roller 85K and on the upstream side of the drive roller 82. The downstream guide roller 86 is configured to come into abutment with the transfer belt 81 on a common inner tangential line between the primary transfer roller 85K and the photoconductor drum 21 at the primary transfer position TR1 formed by the monochrome primary transfer roller 85K by coming into abutment with the photoconductor drum 21 of the image forming station K.

The drive roller 82 drives the transfer belt 81 to circulate in the direction indicated by the arrow D81 and also serves as a backup roller of the secondary transfer roller 121. The drive roller 82 is formed on the peripheral surface thereof with a rubber layer having a thickness of approximately 3 mm and a resistivity of 1000 kΩ.cm or lower, and is grounded via a metallic shaft, so that a conductive path of a secondary transfer bias supplied from a secondary transfer bias generating unit, not shown, via the secondary transfer roller 121 is created. In this manner, by the provision of the rubber layer having a high friction and shock absorbing properties on the drive roller 82, an impact is generated when a sheet enters into an abutting position (a secondary transfer position TR2) between the drive roller 82 and the secondary transfer roller 121 is hardly transferred to the transfer belt 81, so that deterioration of the image quality is prevented.

The paper feeding unit 11 includes a paper feeder having a paper feeding cassette 77 which can hold a stack of sheets therein, and a pickup roller 79 which feeds the sheets from the paper feeding cassette 77 one by one. The sheet is fed from the paper feeder by the pickup roller 79 and is adjusted in paper feeding timing by a resistant roller pair 80 and then is fed to the secondary transfer position TR2 along the sheet guiding member 15.

The secondary transfer roller 121 is provided so as to be capable of coming into and out of contact with the transfer belt 81, and is driven by a secondary transfer roller driving mechanism (not shown) to come into and out of contact therewith. The fixing unit 13 includes a rotatable heat roller 131 having a heater such as a halogen heater integrated therein and a press unit 132 configured to press and urge the heat roller 131. Then, the sheet on which the image is secondarily transferred to the surface thereof is guided to a nip portion formed by the heat roller 131 and a pressurized belt 1323 of the press unit 132 by the sheet guiding member 15, and the image is thermally fixed at the nip portion at a predetermined temperature. The press unit 132 includes two rollers 1321 and 1322, and the pressurized belt 1323 to be wound therearound. Then, by pressing the part of the surface of the pressurized belt 1323 tensed by the two rollers 1321 and 1322 against the peripheral surface of the heat roller 131, the nip portion formed by the heat roller 131 and the pressurized belt 1323 is widely secured. The sheet after having been subjected to the fixation process is transported to a paper discharge tray 4 provided on an upper surface of the housing body 3.

In this apparatus, a cleaner unit 71 is disposed so as to oppose the blade-opposed roller 83. The cleaner unit 71 includes a cleaner blade 711 and a waste toner box 713. The cleaner blade 711 comes into abutment at a distal end thereof with the blade-opposed roller 83 via the transfer belt 81 to remove foreign substances such as toner or paper powder remaining on the transfer belt after the secondary transfer. Then, the foreign substance removed in this manner is collected in the waste toner box 713.

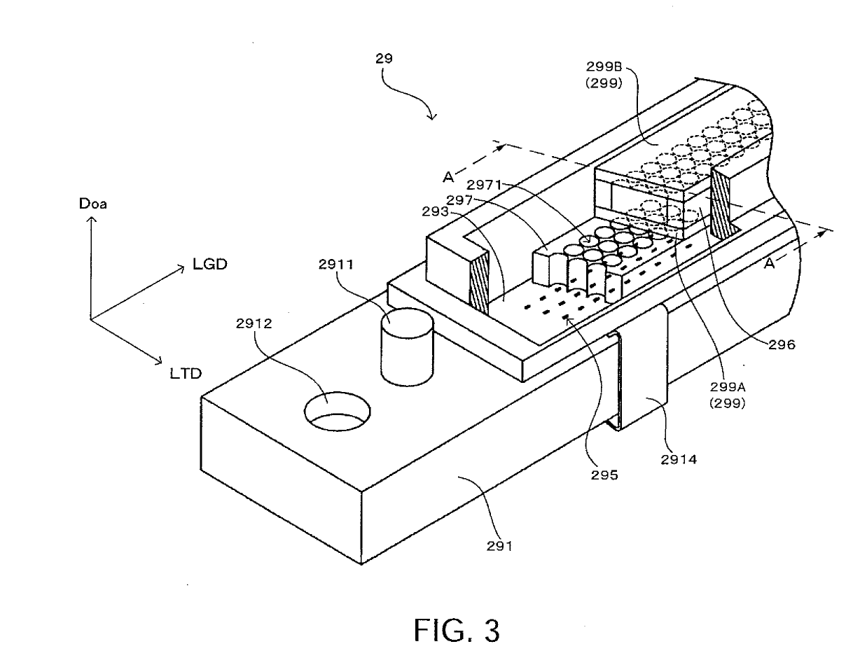

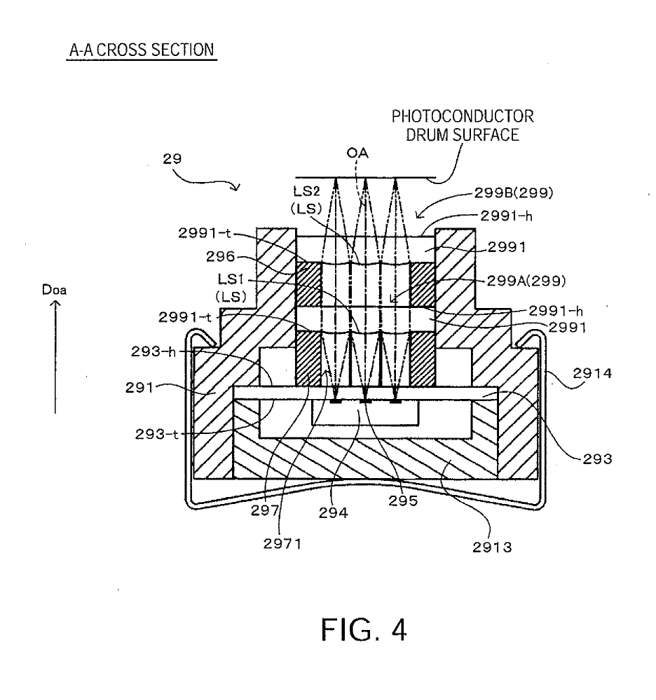

FIG. 3 is a perspective view schematically showing the line head. FIG. 4 is a cross-sectional view of the line head taken along the line A-A in FIG. 3, which is a cross section extending in parallel to optical axes of the lenses. The line A-A extends in parallel or substantially parallel to a light-emitting element group column 295C or a lens column LSC, described later. As described above, a longitudinal direction LGD of the line head 29 extends in parallel or substantially parallel to the primary scanning direction MD, a widthwise direction LTD of the line head 29 extends in parallel or substantially parallel to the secondary scanning direction SD, and the longitudinal direction LCD and the widthwise direction LTD of the line head 29 are orthogonal or substantially orthogonal to each other. The respective light-emitting elements provided on the line head 29 each emit a light beam toward the surface of the photoconductor drum 21. Therefore, in this specification, a direction orthogonal to the longitudinal direction LGD and the widthwise direction LTD and directed from the light-emitting elements to the photoconductor drum surface is referred to as a direction of travel Doa of light beams. The direction of travel Doa of light beams extends in parallel or substantially parallel to an optical axis OA (FIG. 4).

The line head 29 includes a case 291, and is formed with positioning pins 2911 and screw insertion holes 2912 at both ends of the case 291 in terms of the longitudinal direction LGD. The line head 29 is positioned with respect to the photoconductor drum 21 by fitting the positioning pins 2911 to positioning holes (not shown) formed on a photoconductor cover (not shown) covering the photoconductor drum 21 and positioned with respect to the photoconductor drum 21. Then, the line head 29 is positioned and fixed with respect to the photoconductor drum 21 by screwing fixing screws into screw holes (not shown) of the photoconductor cover via the screw insertion holes 2912 and fixing the same.

Arranged in the interior of the case 291 are a head substrate 293, a light-shielding member 297, and two lens arrays 299 (299A and 299B). The interior of the case 291 comes into abutment with a front surface 293-h of the head substrate 293, and a back lid 2913 comes into abutment with a back surface 293-t of the head substrate 293. The back lid 2913 is pressed inwardly of the interior of the case 291 by a fixing instrument 2914 via the head substrate 293. In other words, the fixing instrument 2914 has a resilient force for pressing the back lid 2913 inwardly of the case 291 (upward in FIG. 4), and the interior of the case 291 is sealed so as to be in a light-tight manner (in other words, so as not to allow the light from leaking from the interior of the case 291, and so as to prevent the light from entering from the outside of the case 291) by the back lid being pressed by the resilient force. The fixing instrument 2914 is provided at a plurality of positions in the longitudinal direction LGD of the case 291.

A light-emitting element group 295 including a grouped plurality of light-emitting elements is provided on the back surface 293-t of the head substrate 293. The head substrate 293 is formed of a light-transmissive member such as glass and light beams emitted from the respective light-emitting elements of the light-emitting element group 295 are allowed to be transmitted from the back surface 293-t to the front surface 293-h of the head substrate 293. The light-emitting elements are bottom-emission type organic EL (Electro-Luminescence) elements, and are covered with a sealing member 294.

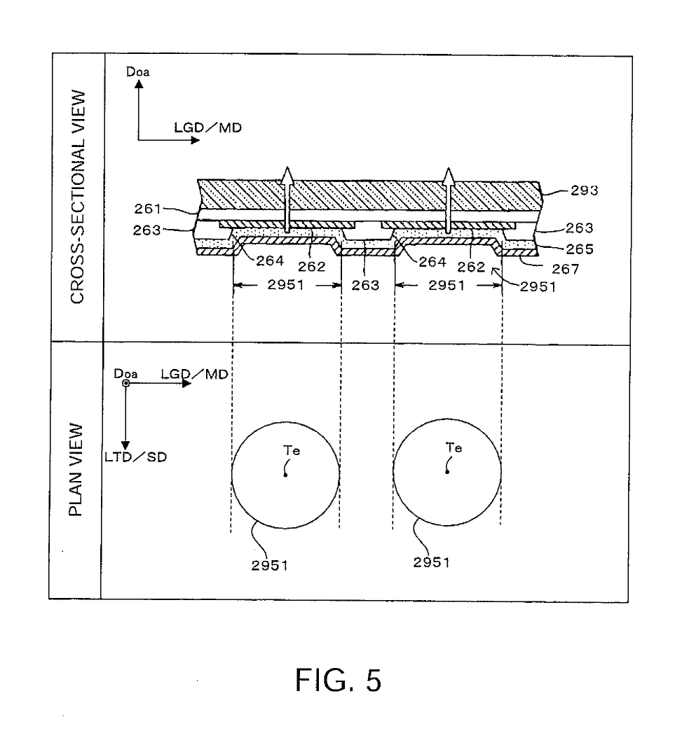

FIG. 5 is a drawing showing a structure of the light-emitting elements, and includes a partial cross-sectional view showing a vertical structure of the light-emitting element (“CROSS-SECTIONAL VIEW” on the upper side in FIG. 5), and a plan view showing a plan structure of the light-emitting elements (“PLAN VIEW” on the lower side in FIG. 5). As shown in FIG. 5, a wiring layer 261 is formed on a back surface of the head substrate 293. Although not shown in the drawing, the wiring layer 261 includes conductive layers and insulative layers laminated one on top of another. The conductive layer is a layer having a positive element (transistor) for controlling the light intensity of a light-emitting element 2951 and wires for transmitting various signals. The insulative layer is laminated so as to electrically insulate the respective conductive layers. First electrodes 262 are formed on a surface of the wring layer. The first electrodes 262 are each formed of a light-transmitting conductive material such as ITO (Indium Tin Oxide), and function as an anode of each light-emitting element 2951.

An insulating layer 263 is formed so as to be laminated on the wiring layer 261 and the first electrode 262. The insulating layer 263 is an insulative film member. The insulating layer 263 is formed with openings 264 at areas overlapped with the first electrodes 262 when viewed in the direction of travel Doa of light beams. The openings 264 are formed as holes penetrated through the insulating layer 263 in the direction of thickness thereof for the respective first electrodes 262. The first electrodes 262 and the insulating layer 263 are covered with a light-emitting layer 265 formed of an organic EL material. The light-emitting layer 265 is formed over a plurality of the light-emitting elements 2951 continuously by a film forming technology such as the spin coat method. Although the light-emitting layer 265 is formed continuously over the plurality of light-emitting elements 2951, the first electrodes 262 are formed independently for the respective light-emitting elements 2951. Therefore, the light intensities of the respective light-emitting elements 2951 are controlled independently for the respective light-emitting elements 2951 according to electric currents fed from the first electrodes 262. For example, the light-emitting layer 265 may be formed for the respective light-emitting elements 2951 by a printing technology such as a liquid drop ejecting method (ink jet method) as a matter of course.

A second electrode 267 is formed so as to be laminated on the light-emitting layer 265. The second electrode 267 is a light-reflective conductive film, and is formed continuously over the plurality of light-emitting elements 2951. In this manner, the light-emitting layer 265 is sandwiched between the first electrodes 262 and the second electrode 267 in the vertical direction, and emits light at an intensity according to the drive current flowing from the first electrodes 262 to the second electrode 267. The emitted light from the light-emitting layer 265 toward the first electrodes 262 and a reflective light reflected from a surface of the second electrode 267 passes through the first electrodes 262 and the head substrate 293 and is emitted toward an image forming optical system, described later, as shown by hollow arrows in FIG. 5. Since the electric current does not flow in an area between the first electrodes 262 and the second electrode 267 with the intermediary of the insulating layer 263, a portion of the light-emitting layer 265 overlapped with the insulating layer 263 does not emit light. In other words, as shown in FIG. 5, portions of the laminated structure including the first electrodes 262, the light-emitting layer 265, and the second electrode 267 located inside the openings 264 function as the light-emitting elements 2951. Therefore, the positions and the configurations (size and shape) of the light-emitting elements 2951 in plan view viewed from the direction of travel Doa of light beams are determined according to the position and the configurations of the openings 264 (see “PLAN VIEW” in FIG. 5). Therefore, in the drawings of this specification, the light-emitting elements 2951 in plan view viewed from the direction of travel Doa of light beams are illustrated by the openings 264 as representatives. Also, in this specification, although the expression “the position of the light-emitting element 2951” is used as needed, a position Te of the light-emitting element 2951 means a geometric center of gravity of (the opening 264 of) the light-emitting element 2951 in plan view. The center of the light-emitting element 2951 corresponds to the geometric center of gravity of the light-emitting element shape.

The respective light-emitting elements 2951 formed on the head substrate 293 in this manner emit light beams having the same wavelength. The light-emitting elements 2951 are so-called complete diffuse surface light sources, and the light beams emitted from the light-emitting surfaces follow Lambert's cosign law.

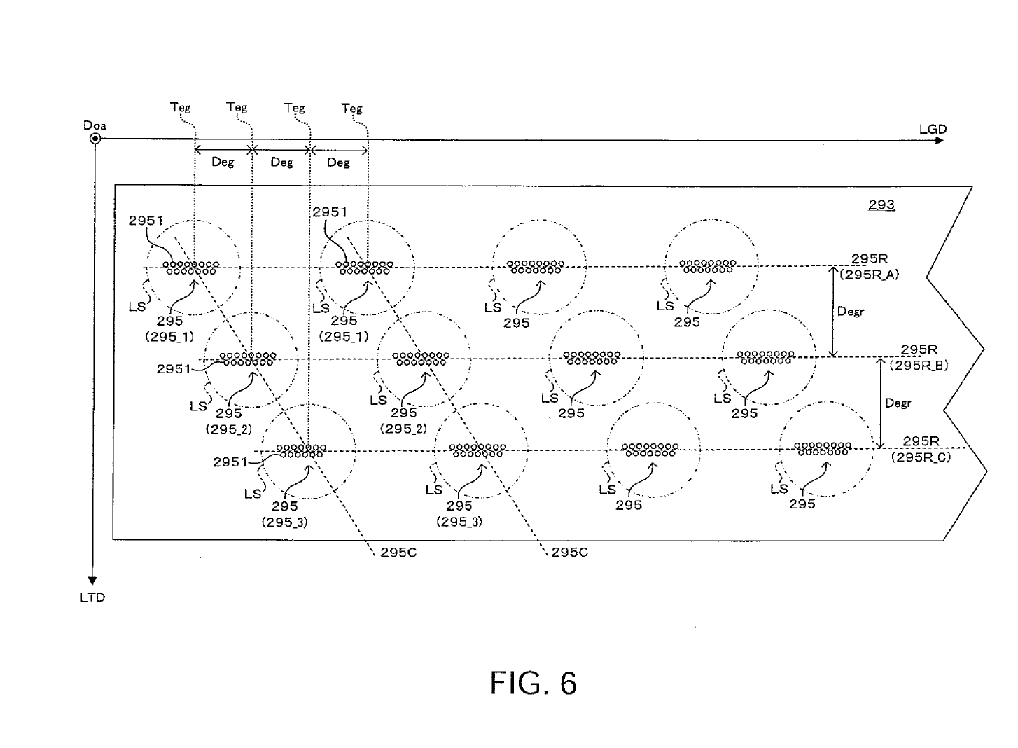

FIG. 6 is a plan view showing a configuration of a back surface of the head substrate, which corresponds to the case where the back surface is viewed from the side of a front surface of the head substrate. In FIG. 6, lenses LS are shown by double-dashed chain lines. However, they are shown only for indicating the correspondence between the light-emitting element group 295 and the lenses LS, and not for indicating that the lenses LS are formed on the back surface 293-t of the head substrate. As shown in FIG. 6, the one light-emitting element group 295 is formed by grouping the fifteen light-emitting elements 2951, and a plurality of the light-emitting element groups 295 are arranged on the back surface 293-t of the head substrate 293. As shown in FIG. 6, the plurality of light-emitting element groups 295 are arranged two-dimensionally on the head substrate 293. Detailed description will be given below.

Three of the light-emitting element groups 295 are arranged at positions different from each other in the widthwise direction LTD so that light-emitting element group columns 295C are formed. The three light-emitting element groups 295 which constitute the light-emitting element group column 295C are arranged at a light-emitting element group distance Deg in the longitudinal direction LGD. A plurality of the light-emitting element group columns 295C are arranged at a light-emitting element group column distance (=Deg×3) in the longitudinal direction LGD. In this manner, the respective light-emitting element groups 295 of the head substrate 293 are arranged at the light-emitting element group distance Deg in the longitudinal direction LGD, and positions Teg of the respective light-emitting element groups 295 in the longitudinal direction LGD are different from each other.

In a different view, the light-emitting element groups 295 can be said to be arranged as follows. In other words, on the back surface 293-t of the head substrate 293, the plurality of light-emitting element groups 295 are arranged in the longitudinal direction LGD to constitute a light-emitting element group row 295R and three of the light-emitting element group rows 295R are provided at positions different from each other in the widthwise direction LTD. These three light-emitting element group rows 295R are arranged at a light-emitting element group row distance Degr in the widthwise direction LTD. In addition, the respective light-emitting element group rows 295R are shifted in the longitudinal direction LGD by a length corresponding to the light-emitting element group distance Deg. Therefore, the respective light-emitting element groups 295 of the head substrate 293 are arranged at the light-emitting element group distance Deg in the longitudinal direction LGD, and the positions Teg of the respective light-emitting element groups 295 in the longitudinal direction LGD are different from each other.

The position of the light-emitting element group 295 is obtained as a center of gravity of the light-emitting element group 295 when viewed in the direction of travel Doa of light beams. The center of gravity of the light-emitting element group 295 is obtained as the center of gravity of the plurality of light-emitting elements 2951 when viewing the plurality of light-emitting elements 2951 which constitute the light-emitting element group 295 in the direction of travel Doa of light beams. Also, the light-emitting element group distance Deg is obtained as a distance between the respective positions Teg in the longitudinal direction LGD of the two light-emitting element groups 295 adjacent in position Teg in the longitudinal direction LGD (for example, light-emitting element groups 295_1 and 295_2). In FIG. 6, the positions Teg of the light-emitting element groups 295 in the longitudinal direction LGD are indicated by perpendicular lines drawn from the positions of the light-emitting element groups 295 to the axis in the longitudinal direction LGD.

Referring back to FIG. 3 and FIG. 4, the description will be continued. On the front surface 293-h of the head substrate 293, the light-shielding member 297 is arranged so as to be in abutment therewith. The light-shielding member 297 is formed with light guide holes 2971 respectively for the plurality of light-emitting element groups 295 (in other words, the plurality of light guide holes 2971 are provided in one-to-one correspondence with the plurality of light-emitting element groups 295). The respective light guide holes 2971 are formed on the light-shielding member 297 as holes penetrating through the direction of travel Doa of light beams. Also, two lens arrays 299 are arranged in the direction of travel Doa of light beams in parallel on the upper side of the light-shielding member 297 (the opposite side of the head substrate 293).

In this manner, in the direction of travel Doa of light beams, the light-shielding member 297 formed with the light guide holes 2971 for the respective light-emitting groups 295 is arranged between the light-emitting element groups 295 and the lens arrays 299. Therefore, light beams emitted from the light-emitting element groups 295 pass through the light guide holes 2971 corresponding to the light-emitting element groups 295 and proceed to the lens arrays 299. Conversely, part of the light beams emitted from the light-emitting element groups 295 proceeding to portions other than the light guide holes 2971 corresponding to the light-emitting element groups 295 are shielded by the light-shielding member 297. In this manner, entry of stray light proceeding to portions other than the light guide holes 2971 into the lens array 299 is restricted by the light-shielding member 297.

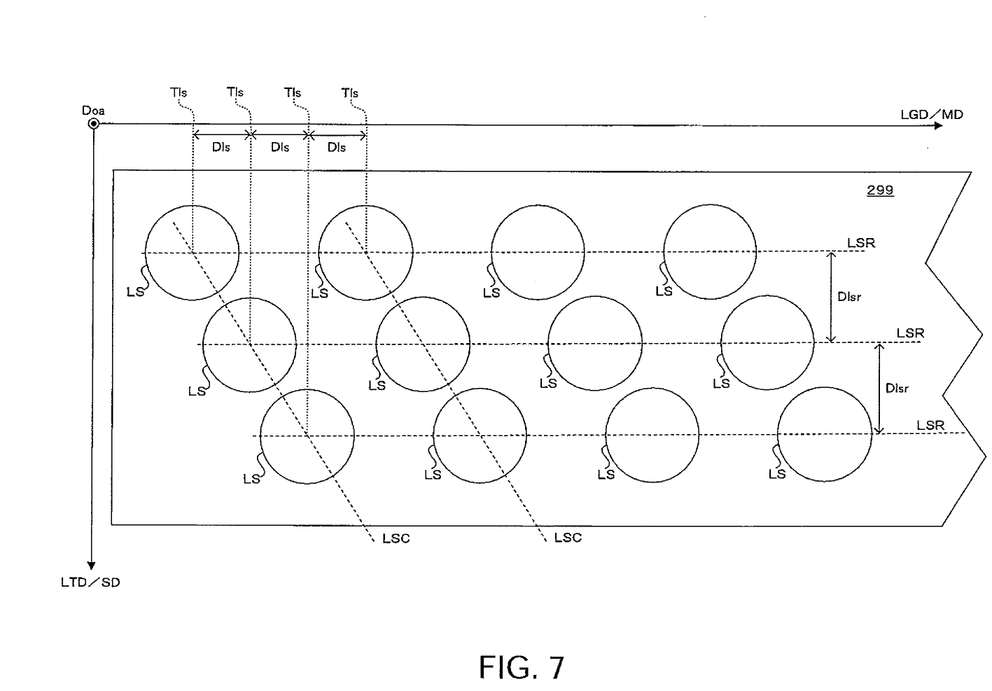

FIG. 7 is a plan view showing a configuration of the lens array, which corresponds to a case of viewing the lens array from the side of the image surface (the side of the direction of travel Doa of light beams). The respective lenses LS in FIG. 7 are formed on a back surface 2991-t of a lens array substrate 2991, and FIG. 7 shows a configuration of the back surface 2991-t of the lens array substrate. As shown in FIG. 6 as well, in the lens array 299, the lenses LS are provided respectively for the light-emitting element groups 295. In other words, in each of the lens arrays 299, the plurality of lenses LS are arranged two-dimensionally. Detailed description will be given below.

Three of the lenses LS are arranged at positions different from each other in the widthwise direction LTD, so that the lens columns LSC are formed. The three lenses LS which constitute the lens column LSC are arranged at a lens-to-lens distance Dls in the longitudinal direction LGD. In addition, a plurality of lens columns LSC are arranged at a lens column distance (=Dls×3) in the longitudinal direction LGD. In this manner, the respective lenses LS of the lens arrays 299 are arranged at a lens-to-lens distance Dls in the longitudinal direction LGD, and positions Tls in the longitudinal direction LGD of the respective lenses LS are different from each other.

In a different view, the lenses LS are arranged as follows. In other words, the plurality of lenses LS are arranged in the longitudinal direction LGD to constitute a lens row LSR, and three of the lens rows LSR are provided at positions different from each other in the widthwise direction LTD. These three lens rows LSR are arranged at a lens row distance Dlsr in the widthwise direction LTD. In addition, the respective lens rows LSR are shifted in the longitudinal direction LGD by a length corresponding to a lens column distance Dls. Therefore, the respective lenses LS of the lens arrays 299 are arranged at the lens column distance Dls in the longitudinal direction LGD, and the positions Tls in the longitudinal direction LGD of the respective lenses LS are different from each other.

In FIG. 7, the positions of the lenses LS are represented by apexes of the lens LS (that is, points having a maximum sag), and the positions Tls of the lenses LS in the longitudinal direction LGD are indicated by perpendicular lines drawn from the apexes of the lenses LS to the axis in the longitudinal direction LGD.

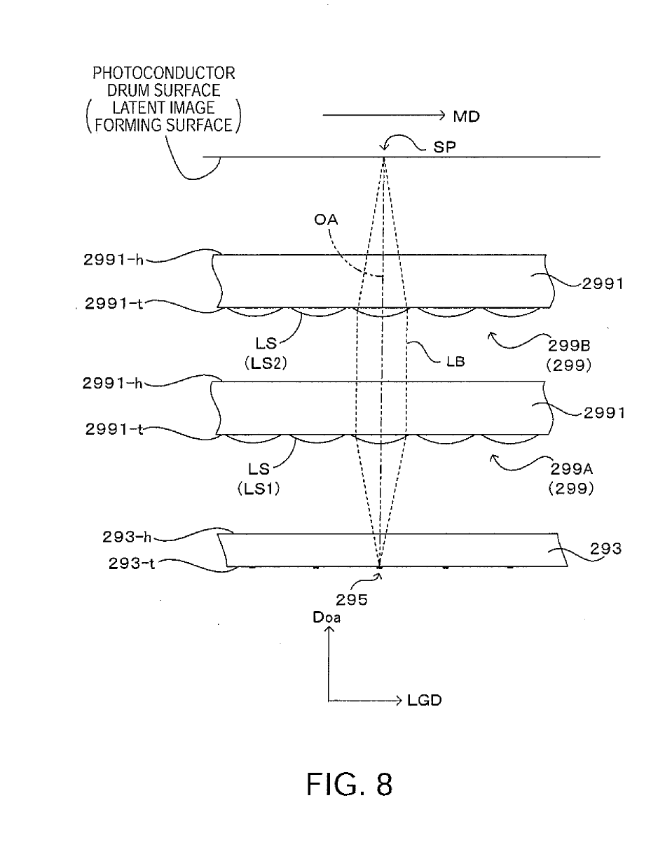

FIG. 8 is a cross-sectional view in the longitudinal direction of the lens arrays and the head substrate, showing a longitudinal cross section including the optical axis of the lens LS formed on the lens arrays. The lens arrays 299 are elongated in the longitudinal direction LGD, and have the light-transmissive lens array substrates 2991. The lens array substrates 2991 are formed of glass having a relatively small linear expansion coefficient. The back surface 2991-t of the lens array substrates 2991 from between the front surface 2991-h and the back surface 2991-t of the each lens array substrate 2991 is formed with the lenses LS. The lenses LS may be formed of, for example, photo-curing resin.

In this line head 29, the two lens arrays 299 (299A and 299B) having such a configuration are arranged in the direction of travel Doa of light beams in parallel to each other in order to achieve the improvement of flexibility in optical design. These two lens arrays 299A and 299B oppose each other with the intermediary of a base seat 296 (FIG. 3 and FIG. 4), and the base seat 296 has a function to define the distance between the lens arrays 299A and 299B. In this manner, two lenses LS1 and LS2 arranged in the direction of travel Doa of light beams are arranged for the respective light-emitting element groups 295 (FIG. 3, FIG. 4 and FIG. 8). Here, the lenses LS on the lens array 299A on the upstream side in the direction of travel Doa of light beams is the first lenses LS1, and the lenses LS on the lens array 299B on the downstream side in the direction of travel Doa of light beams are the second lenses LS2.

Light beams LB emitted from the light-emitting element group 295 are formed into images by the two lenses LS1 and LS2 arranged so as to oppose the light-emitting element group 295, so that spots SP are formed on the photoconductor drum surface (the latent image forming surface). In other words, an image forming optical system is constituted by the two lenses LS1 and LS2 and the image forming optical system is arranged so as to oppose each light-emitting element group 295. The optical axis OA of the image forming optical system extends in parallel to the direction of travel Doa of light beams, and passes through the position of the center of gravity of the light-emitting element group 295. The image forming optical system is so-called an inversion optical system and the image forming optical system forms an inverted image.

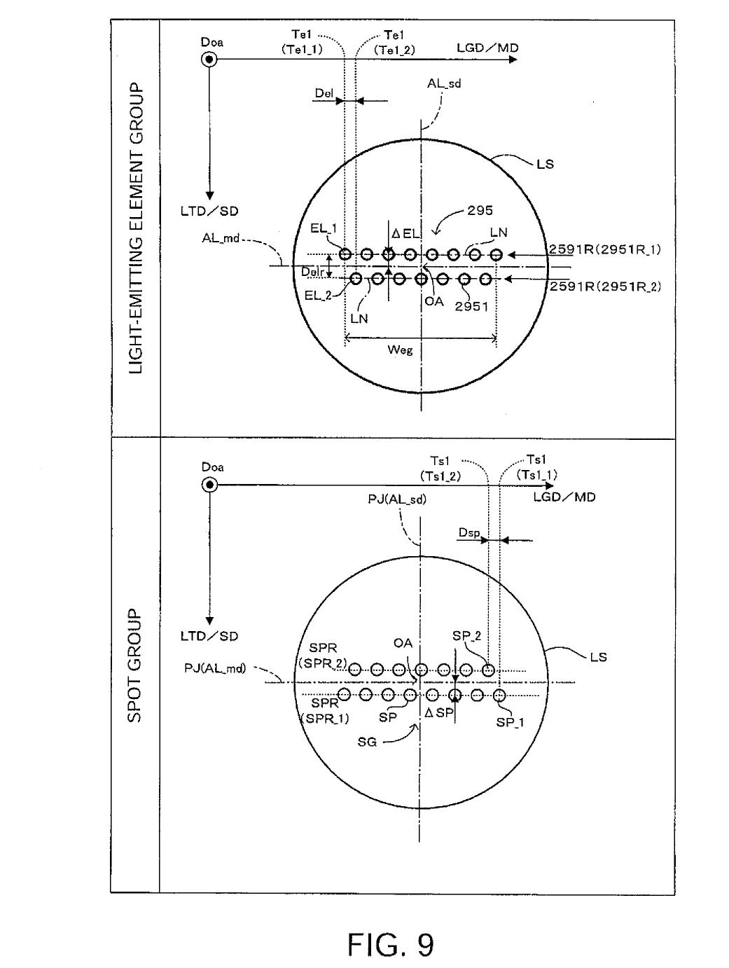

FIG. 9 is a plan view showing a configuration of the light-emitting element group and the spot forming action by the corresponding light-emitting element group. First of all, the configuration of the light-emitting element group will be described while referring to the column of the “LIGHT-EMITTING ELEMENT GROUP” in FIG. 9. In the same column, a first linear line AL_md is a linear line passing through the optical axis OA and extending in parallel to the primary scanning direction MD, and a second linear line AL_sd is a linear line passing through the optical axis OA and extending in parallel to the secondary scanning direction SD. The first linear line AL_md and the second linear line AL_sd are virtual lines on the back surface 293-t of the head substrate formed with the light-emitting elements 2951.

In the light-emitting element group 295, the fifteen light-emitting elements 2951 are arranged in two rows in a zigzag pattern in the longitudinal direction LGD, and the respective light-emitting elements 2951 are formed at positions different from each other in terms of the longitudinal direction LGD. These light-emitting elements 2951 are arranged in the longitudinal direction LGD at a light-emitting element center distance Del. Here, the light-emitting element center distance Del is a distance in the longitudinal direction LGD (primary scanning direction MD) between the two light-emitting elements 2951 (for example, light-emitting elements EL_1 and EL_2) adjacent in position in a primary direction Tel (the position in the longitudinal direction LGD or, in the primary scanning direction MD) (for example, the distance between positions in primary direction Tel_1 and Tel_2). In FIG. 9, the positions in the primary direction Tel are indicated by perpendicular lines drawn from the positions Te of the light-emitting elements 2951 to the axis in the longitudinal direction LGD (axis in the primary scanning direction MD). For the convenience of description below, the two light-emitting elements 2951 in a relation in which the position in primary directions Tel are adjacent to each other as the light-emitting elements EL_1 and EL_2 are referred to as the “adjacent light-emitting element pair”.

The light-emitting element group 295 is arranged so as to constitute light-emitting element rows 2951R. The light-emitting element rows 2951R include two or more light-emitting elements 2951 arranged at positions different from each other in terms of the longitudinal direction LGD. More specifically, a light-emitting element row 2951R_1 includes the eight light-emitting elements 2951 arranged at a distance double the light-emitting element center distance Del in the longitudinal direction LGD, and a light-emitting element row 2951R_2 includes the seven light-emitting elements 2951 at a distance double the light-emitting element center distance Del in the longitudinal direction LGD. The light-emitting element rows 2951R_1 and 2951R_2 are arranged in the widthwise direction LTD at a light-emitting element row distance Delr and is arranged at positions different from each other in terms of the widthwise direction LTD. In addition, the respective light-emitting element rows 2951R_1 and 2951R_2 are arranged so as to be shifted from each other in the longitudinal direction LGD by a length corresponding to the light-emitting element center distance Del.

The light-emitting element rows 2951R each include a plurality of light-emitting elements 2951 arranged linearly. In other words, the light-emitting element rows 2951R each include a plurality of light-emitting elements 2951 arranged at the same positions in terms of the widthwise direction LTD. Therefore, as exemplified using the light-emitting element row 2951R_1, distances ΔEL (the element optical axis distances in secondary direction ΔEL) between the light-emitting elements 2951 and the first linear line AL_md in terms of the widthwise direction LTD are the same for all these light-emitting elements 2951. In the same column in FIG. 9, a line LN (virtual line) is indicated for showing the state of arrangement of the light-emitting elements 2951. The element optical axis distance in the secondary direction ΔEL can be obtained as a distance between the positions Te of the light-emitting elements 2951 and the first linear line AL_md in terms of the widthwise direction LTD.

The light-emitting element group 295 configured in this manner has a light-emitting element group width Weg=(15-1)×Del. Here, the light-emitting element group width Weg is a distance between the respective positions Te of the light-emitting elements 2951 located at both ends of the light-emitting element group 295 in terms of the longitudinal direction LGD. The light-emitting element group 295 is in symmetry with respect to the second linear line AL_sd.

Subsequently, the spot forming action by the light-emitting element group will be described referring to the column of “SPOT GROUP” in FIG. 9. In this column, a first projecting line PJ (AL_md) is a virtual line obtained by projecting the first linear line AL_md on the photoconductor drum surface in the direction of travel Doa of light beams, and a second projecting line PJ (AL_sd) is a virtual line obtained by projecting the second linear line AL_sd on the photoconductor drum surface in the direction of travel Doa of light beams.

Light beams emitted from the respective light-emitting elements 2951 in the light-emitting element row 2951R_1 are formed into inverted images by the image forming optical systems so that a spot row SPR_1 is formed. The spot row SPR_1 includes eight spots SP arranged in the primary scanning direction MD at a pitch double a spot center distance Dsp. The light beams emitted from the light-emitting elements 2951 of the light-emitting element row 2951R_2 are formed into inverted images by the image forming optical systems so that a spot row SPR_2 is formed. The spot row SPR_2 includes seven spots SP arranged in the primary scanning direction MD at a distance double the spot center distance Dsp. In this manner, the respective light-emitting element rows 2951R are able to form the spot rows SPR including the plurality of spots SP in the primary scanning direction MD by causing the plurality of light-emitting elements 2951 to emit light beams simultaneously. In the respective spot rows SPR, the plurality of spots SP are arranged at the same position in terms of the secondary scanning direction SD. Therefore, as exemplified using the spot row SPR_1, distances ΔSP (spot optical axis distances in secondary direction ΔSP) between the spots SP and the first projecting line PJ (AL_md) in terms of the secondary scanning direction SD are the same for all these spots SP. The spot optical axis distance in secondary direction ΔSP can be obtained as a distance between the positions of center of gravity of the spots SP and the first projecting line PJ (AL_md) in terms of the secondary scanning direction SD.

The spot rows SPR_1 and SPR_2 are formed in parallel at positions different from each other in terms of the secondary scanning direction SD. In addition, the respective spot rows SPR_1 and SPR_2 are formed so as to be shifted from each other in the longitudinal direction LGD by a length corresponding to the spot center distance Dsp. Accordingly, a spot group SG including the fifteen spots SP arranged two-dimensionally is formed. As shown in the same column in FIG. 9, in the spot group SG, these fifteen spots SP are arranged in the primary scanning direction MD at the spot center distance Dsp, and the respective spots are at positions different from each other in terms of the primary scanning direction MD. Here, the spot center distance Dsp is a distance in the primary scanning direction MD between the two spots (for example, spots SP_1 and SP_2) adjacent in position in the primary direction Tsl (the position in the primary scanning direction MD) (for example, the distance between the positions in the primary direction Tsl_1 and Tsl_2). In FIG. 9, the positions in the primary direction Tsl are indicated by perpendicular lines drawn from the centers of the spots SP to the axis in the primary scanning direction MD. The center of the spot SP is as follows.

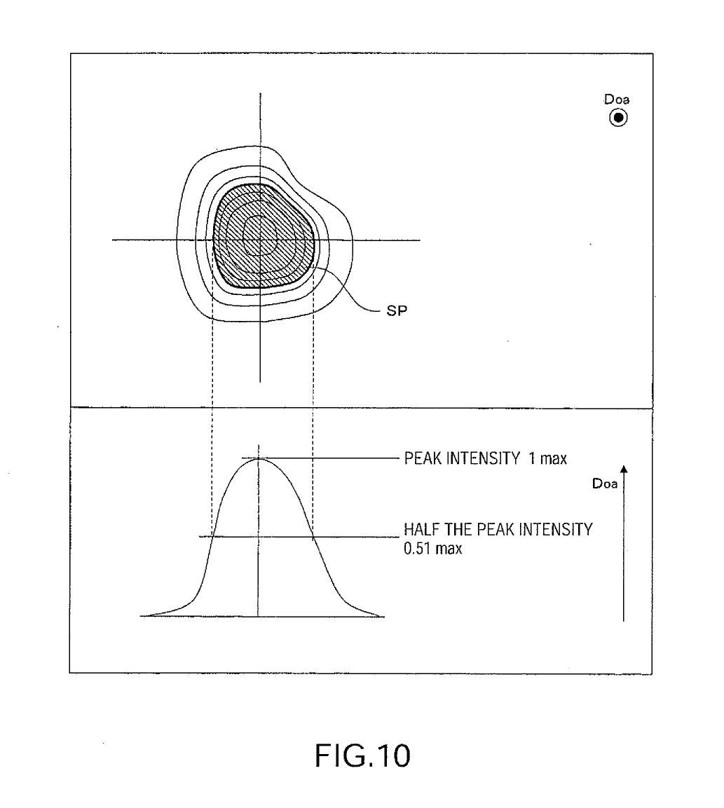

FIG. 10 is an explanatory drawing of the spot center. The upper column in FIG. 10 shows a beam profile of a spot viewed in the direction of travel Doa of light beams. In the same column, the beam profile is indicated by isointensity lines. The lower column in FIG. 10 shows a beam profile in cross section including the direction of travel Doa of light beams. An area having an intensity not lower than 0.5 Imax, which is half the peak intensity Imax of the beam profile (hatched area in the upper column) corresponds to the spot SP. The geometric center of gravity of the spot SP defined in this manner corresponds to the center of the spot SP.

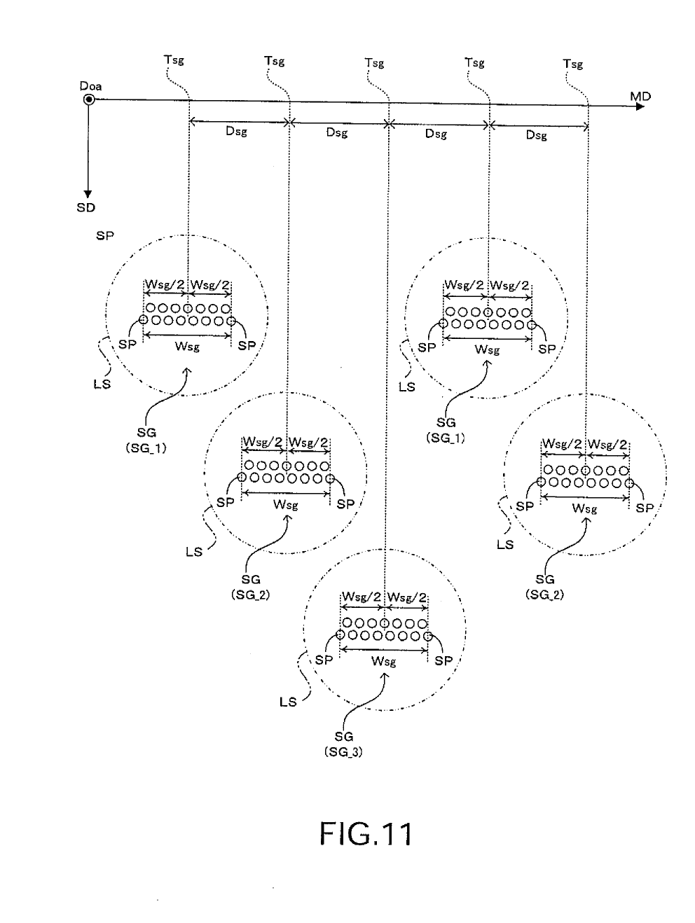

As shown in FIG. 6, the plurality of light-emitting element groups 295 are arranged discretely and two-dimensionally. Therefore, when the respective light-emitting element groups 295 emit light beams simultaneously, a plurality of spot groups SG are formed on the surface of the photoconductor drum 21 discretely and two-dimensionally (FIG. 11). Here, FIG. 11 is a plan view showing the spot groups formed on the photoconductor drum surface when the respective light-emitting element groups emit light beams simultaneously. In FIG. 11, the lenses LS are shown by double-dashed chain lines. However, they are shown only for indicating the correspondence between the spot groups SG and the lenses LS, and not for indicating that the lenses LS are formed on the photoconductor drum surface. Also, spot groups SG_1, SG_2 and SG_3 or spot groups formed respectively by the light-emitting element groups 295_1, 295_2, and 295_3.

Detailed positions of formation of the spot groups SG are as follows. In other words, the plurality of spot groups SG_1, SG_2 and SG_3 . . . are arranged in the primary scanning direction MD at a spot group distance Dsg in this order. The adjacent three spot groups SG_1, SG_2 and SG_3 are at positions different in terms of the secondary scanning direction SD.

The center distance between spots SP_r and SP_1 located at both ends of the spot group SG in terms of the primary scanning direction MD is expressed as a width Wsg of the spot group SG. The position which divides the spot group width Wsg into halves and corresponds to an intersection of a linear line perpendicular to the primary scanning direction MD and the primary scanning direction MD (in other words, a point obtained by orthogonally projecting the point which divides the spot group width Wsg into halves on the axis in the primary scanning direction MD) is expressed as a position in the primary direction Tsg of the spot group SG. Also, the two spot groups SG whose positions in the primary direction Tsg are adjacent to each other are referred to as “the two spot groups SG adjacent to each other in the primary scanning direction MD”. The spot group distance Dsg is given as a distance between the positions in primary direction Tsg of the spot groups SG adjacent to each other in the primary scanning direction MD.

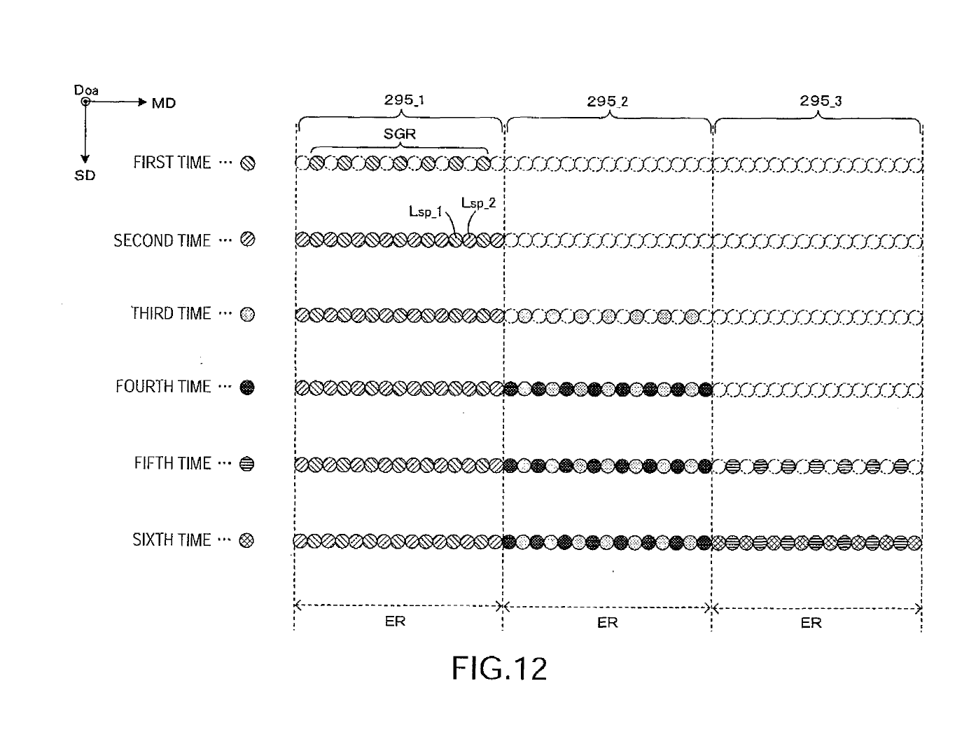

As shown in FIG. 11, when the plurality of light-emitting element groups 295 are illuminated simultaneously, the plurality of spot groups SG are formed discretely and two-dimensionally. Therefore, when a line latent image extending in the primary scanning direction MD using the line head 29 as described above, the light-emitting timings of the respective light-emitting element groups 295 are controlled as follows. FIG. 12 is a drawing showing a latent image forming action by the line head. Referring now to FIG. 6, FIG. 9 and FIG. 12, the latent image forming action by the line head will be described. Briefly, a head control module 54 causes the respective light-emitting elements 2951 at timings according to the movement of the surface of the photoconductor drum 21 in the secondary scanning direction SD to form the plurality of spots SP so as to be arranged in the primary scanning direction MD. Detailed description will be given below.

First of all, when the light-emitting element row 2951R_2 of the light-emitting element groups 295_1 which belongs to a light-emitting element group row 295R_A on the upmoststream emits light beams in the secondary scanning direction SD, the spot row SPR is formed. The area formed with the respective spots SP in this manner is exposed, and the seven spot latent images indicated by a hatching pattern of “FIRST TIME” are formed in FIG. 12. In FIG. 12, hollow rounds indicate spot latent images which are not formed but are expected to be formed later. In FIG. 12, the spots labeled by reference numerals 295_1, 295_2, and 295_3 indicate spot latent images formed by the light-emitting element groups 295 corresponding to the reference numerals assigned thereto respectively.

The light-emitting element row 2951R_1 emits light beams following the light-emitting element row 2951R_2, and eight spot latent images indicated by a hatching pattern of “SECOND TIME” in FIG. 12 are formed. In this manner, the two light-emitting elements 2951 arranged at the light-emitting element center distance Del in the longitudinal direction LGD are able to form the two spot latent images (for example, spot latent images Lsp1 and Lsp2) adjacent to each other in the primary scanning direction MD. The light emission is performed in sequence from the light-emitting element row 2951R on the downstream side in the secondary scanning direction SD in order to accommodate the inversion characteristics of the image forming optical system.

Subsequently, the light-emitting element group 295_2 which belongs to a light-emitting element group row 295R_B on the downstream side of the light-emitting element group row 295R_A in the secondary scanning direction SD performs the light-emitting action as the above-described light-emitting element group row 295R_A to form the spot latent image shown by hatching patterns of “THIRD TIME” to “FOURTH TIME” in FIG. 12. Also, the light-emitting element group 295 (295_3 or the like) which belongs to a light-emitting element group row 295R_C on the downstream side of the light-emitting element group row 295R_B in the secondary scanning direction SD performs the light-emitting action as the above-described light-emitting element, group row 295R_A to form the spot latent image shown by hatching patterns of “FIFTH TIME” to “SIXTH TIME” in FIG. 12. In this manner, by the light-emitting actions performed from the first to the sixth time, the plurality of spot latent images are arranged in the primary scanning direction MD so that the line latent image is formed.

### EMBODIMENTS

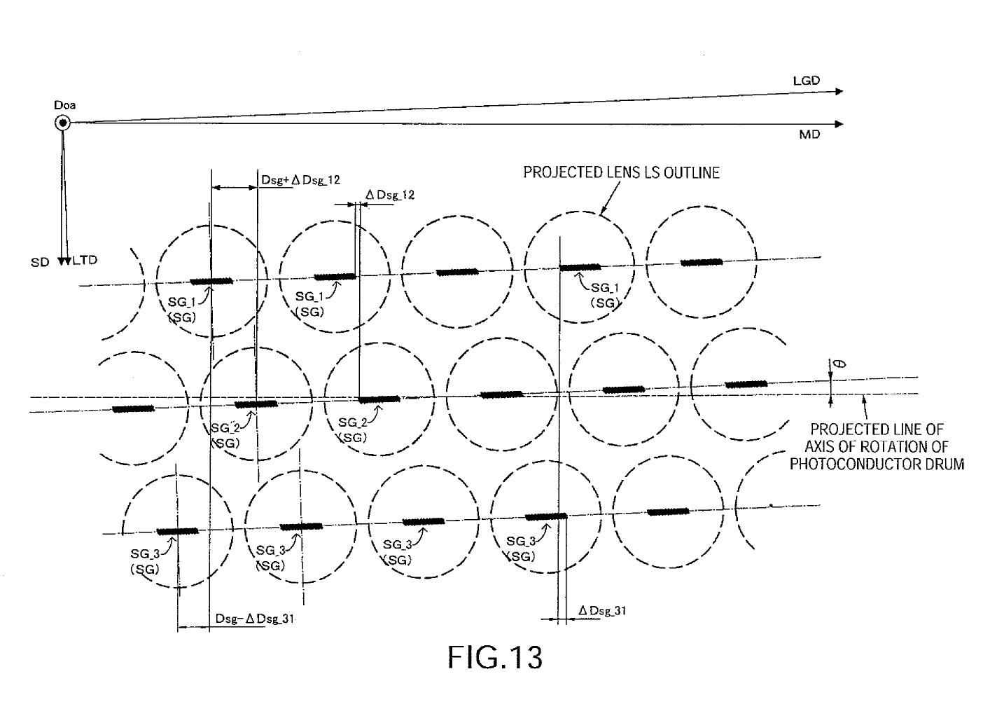

Incidentally, the distance between the spot groups SG adjacent in the primary scanning direction MD might vary by the line head 29 skewed with respect to the photoconductor drum 21. FIG. 13 is a plan view showing a scene where a gap is generated by the skew, and showing the plurality of spot groups SG formed by the simultaneous light emission by the respective light-emitting element groups 295. As shown in FIG. 13, the longitudinal direction LGD of the line head 29 is skewed with respect to the axis of rotation of the photoconductor drum 21 by an angle θ. Due to such a skew, the spot group distance between the two spot groups SG_3 and SG_1 are adjacent to each other in the primary scanning direction MD is reduced from the distance Dsg by a variation width ΔDsg_31. Consequently, the spot groups SG_3 and SG_1 are overlapped by the width ΔDsg_31. In contrast, the spot group distance between the two spot groups SG_1 and SG_2 adjacent to each other in the primary scanning direction MD is elongated by a variation width ΔDsg_12 from the distance Dsg. Consequently, a gap of the width ΔDsg_12 is formed between the spot groups SG_1 and SG_2. However, since the spots SP cannot be formed in such gaps, ranges where the latent image cannot be formed are generated. Consequently, in this embodiment, the line head 29 is configured so as to be capable of forming the two spot groups SG adjacent to each other in the primary scanning direction MD in an overlapped manner in advance (that is, in a state of being free from the skew).

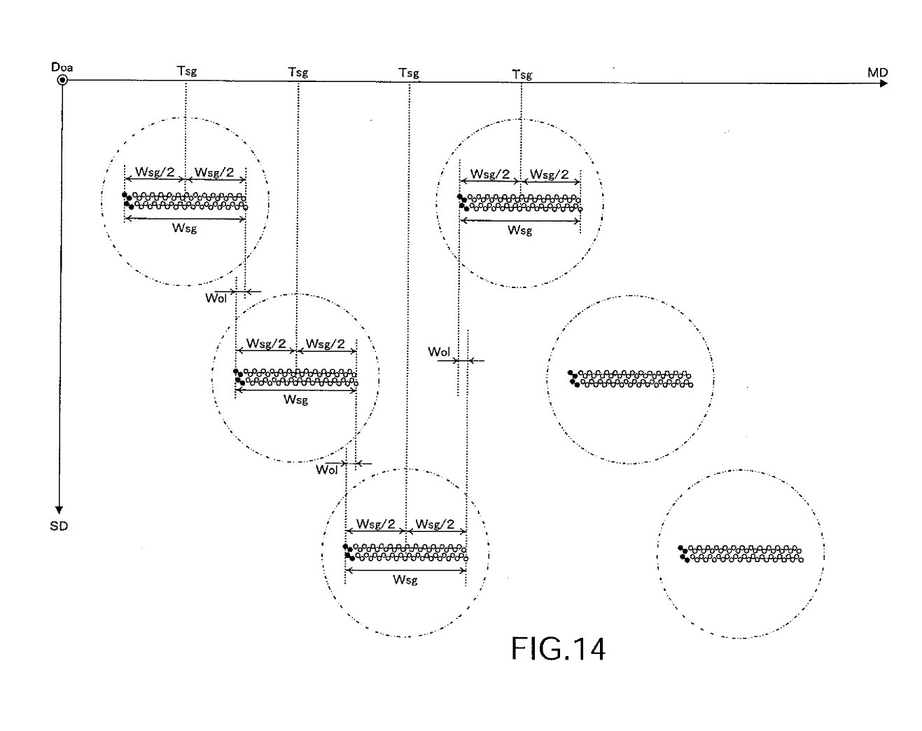

FIG. 14 is a plan view showing the plurality of spot groups formed in this embodiment. In FIG. 14, the lenses LS are shown by double-dashed chain lines. However, they are shown only for indicating the correspondence between the spot groups SG and the lenses LS, and not for indicating that the lenses LS are formed on the photoconductor drum surface. As shown in FIG. 14, the lenses LS at different positions in terms of the widthwise direction LTD form the spot groups SG at positions different from each other in terms of the secondary scanning direction SD. The two spot groups SG adjacent to each other in the primary scanning direction MD are overlapped with each other in the primary scanning direction MD, and the overlapped width is a width Wol. Then, in this embodiment, the spot center distance Dsp of the spots SP formed in an area in which the spot groups SG are overlapped with each other is differentiated between the two spot groups SG. More specifically, the light-emitting element group 295 for forming the spot group SG is configured as described below.

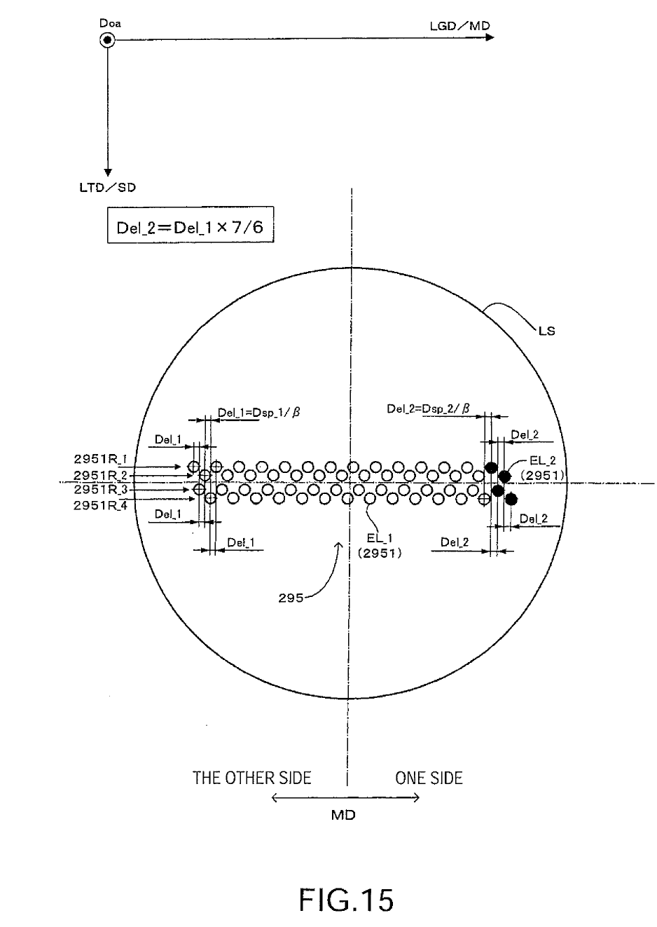

FIG. 15 is a plan view showing a configuration of the light-emitting element group in this embodiment.

As in FIG. 13 and FIG. 14, the lens LS is shown only for indicating the relation between the lens LS and the light-emitting element group 295. As shown in FIG. 15, the light-emitting element group 295 includes the light-emitting element rows 2951R by arranging fourteen light-emitting elements 2951 in the longitudinal direction, and four light-emitting element rows 2951R_1 to 2951R_4 are arranged at positions different from each other in terms of the widthwise direction LTD. The respective light-emitting element rows 2951R_1 to 2951R_4 are shifted from each other in the longitudinal direction LGD and, consequently, 4×14 light-emitting elements 2951 are at positions different from each other in terms of the longitudinal direction LGD.

The light-emitting elements 2951 include first light-emitting elements EL_1 (hollow circles in FIG. 15) arranged in the longitudinal direction LGD at a first light-emitting element center distance Del_1, and second light-emitting elements EL_2 (hatched circles in FIG. 15) arranged in the longitudinal direction LGD at a second light-emitting element center distance Del_2. In other words, the light-emitting element group 295 includes the four second light-emitting elements EL_2 arranged at an end portion on one side in terms of the longitudinal direction LGD. The light-emitting elements 2951 other than these four second light-emitting elements EL_2 correspond to the first light-emitting elements EL_1. The first light-emitting element center distance Del_1 and the second light-emitting element center distance Del_2 satisfy the following expressions:

Del_{—}2=Del_{—}1×7/6.

As described later, the reference sign Dsp_1 designates a first spot center distance, the reference sign Dsp_2 designates a second spot center distance, and the reference sign β designates an absolute value of optical magnification of the image forming optical system. These values satisfy the following expressions:

Del_{—}1=Dsp_{—}1/β

Del_{—}2=Dsp_{—}2/β.

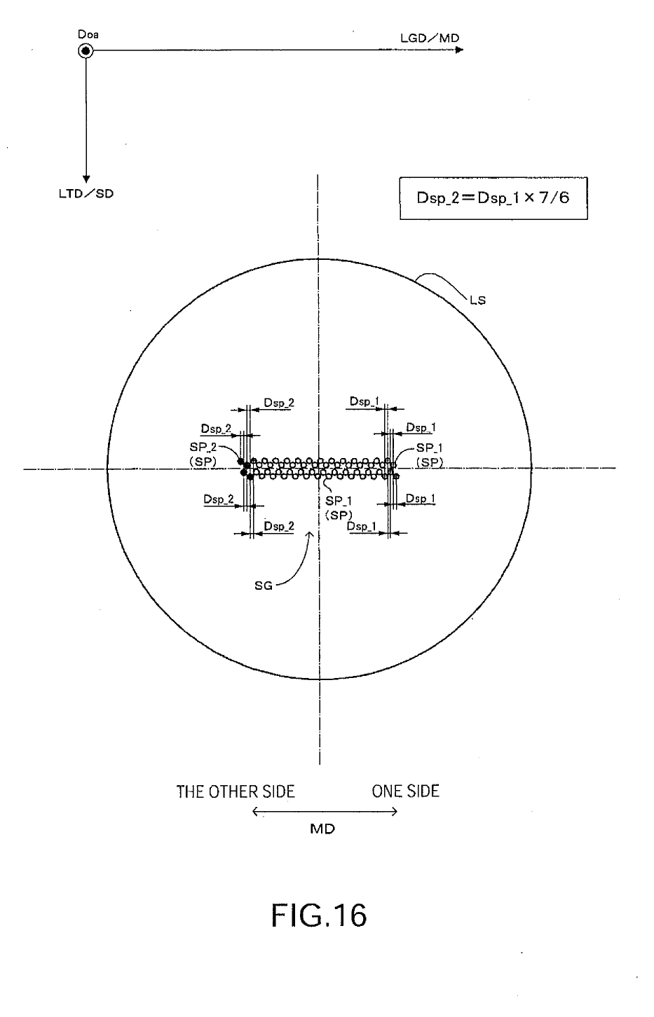

FIG. 16 is a plan view showing the spot group formed by the light-emitting element group. As in FIG. 13 and FIG. 14, the lens LS is shown only for indicating the relation between the lens LS and the spot group SG. As shown in FIG. 16, the light beams emitted from the light-emitting element group 295 are formed into inverted images by the image forming optical systems to form the spot group SG. More specifically, since the respective light-emitting element rows 2951R form the fourteen spots SP arranged linearly in the primary scanning direction MD, 4×14 spots SP in total are formed at positions different from each other in the primary scanning direction MD. In FIG. 16, the spots formed by the first light-emitting elements EL_1 are indicated by hollow circles as first spots SP_1, and the spots formed by the second light-emitting elements EL_2 are indicated by hatched circles as a second spot SP_2. As shown in FIG. 16, the four second spots SP_2 are formed on the other end portion of the spot group SG in terms of the primary scanning direction MD. Also, the light-emitting elements 2951 other than the four second spots SP_2 correspond to the first spots SP_1. The first spots SP_1 are arranged in the primary scanning direction MD at the first spot center distance Dsp_1. In contrast, the four second spots SP_2 are arranged in the primary scanning direction MD at the second spot center distance Dsp_2. The first spot center distance Dsp_1 and the second spot center distance Dsp_2 satisfy the following expression:

Dsp_{—}2=Dsp_{—}1×7/6.

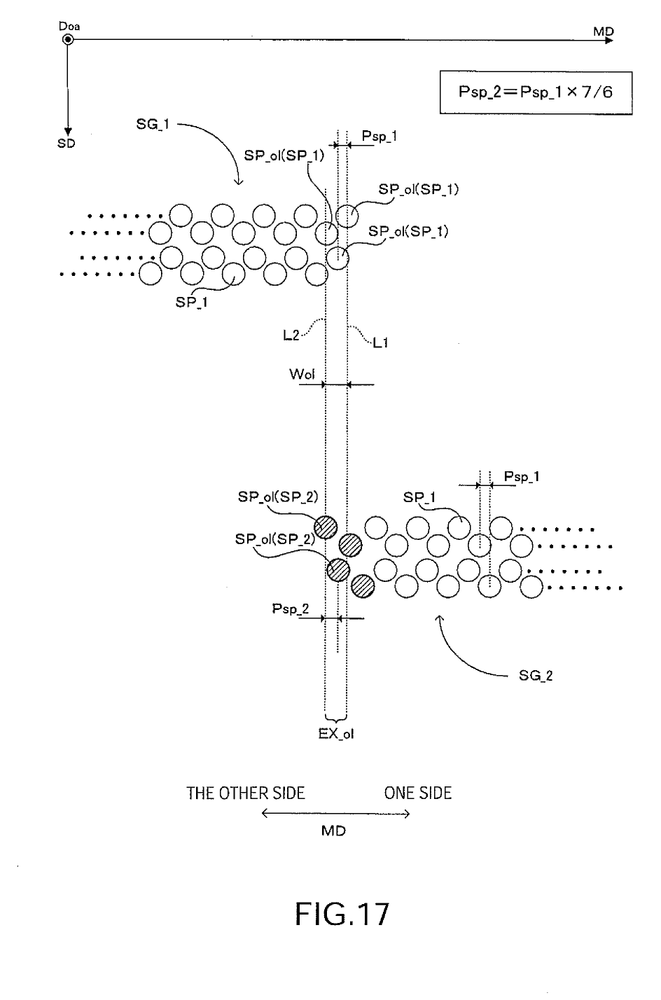

Then, as described above, the two spot groups SG adjacent to each other in the primary scanning direction MD are formed in an overlapped manner. FIG. 17 is an enlarged plan view showing a portion in the vicinity of an overlapped area of the spot groups. The first spots SP_1 are present in one end portion (first end portion) of the spot group SG in terms of the primary scanning direction MD. Also, the second spot SP_2 is present on the other end portion (second end portion) of the spot group SG in terms of the primary scanning direction MD. Then, the one end portion of a spot group SG_1 and the other end portion of a spot group SG_2 are overlapped with each other in terms of the primary scanning direction MD (in other words, when viewed in the direction orthogonal to the primary scanning direction MD). In this manner, the spot groups SG adjacent to each other in the primary scanning direction MD are overlapped with each other to form an overlapped exposed area EX_ol. Here, the overlapped exposed area EX_ol may be defined as follows. In other words, an area interposed between a virtual line L1 and a virtual line L2 corresponds to the overlapped exposed area EX_ol where the virtual line L1 is a line passing through the spot SP which is located at an extremity on one side of the spot group SG in terms of the primary scanning direction MD and extending orthogonally to the primary scanning direction MD and the virtual line L2 is a line passing through the spot SP at an extremity on the other side of the spot group SG in terms of the primary scanning direction MD and extending orthogonally to the primary scanning direction MD. The spots SP having the centers thereof within the overlapped exposed area EX_ol are referred to as overlapped spots Sp_ol. Furthermore, the light-emitting elements 2951 which form the overlapped spot Sp_ol are referred to as overlapped light-emitting elements.

In this embodiment, the overlapped light-emitting elements actually used for forming the latent image are selected according to the width Wol of the overlapped exposed area EX_ol (in other words, according to the extent of overlap between the spot groups SG). In other words, only the overlapped spots Sp_ol corresponding to the selected overlapped light-emitting elements are used for forming the latent image, and the overlapped spots Sp_ol corresponding to the unselected overlapped light-emitting elements are not used for forming the latent image. Such a latent image forming action may be performed by controlling the line head 29 by the head controller HC. Subsequently, the latent forming action will be described below.

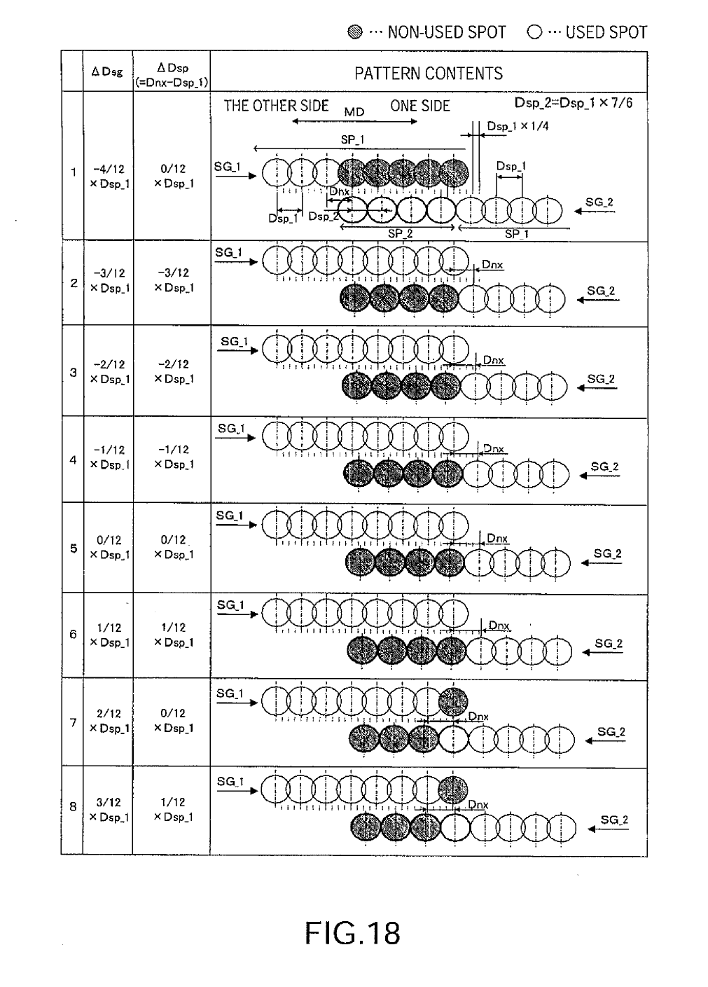

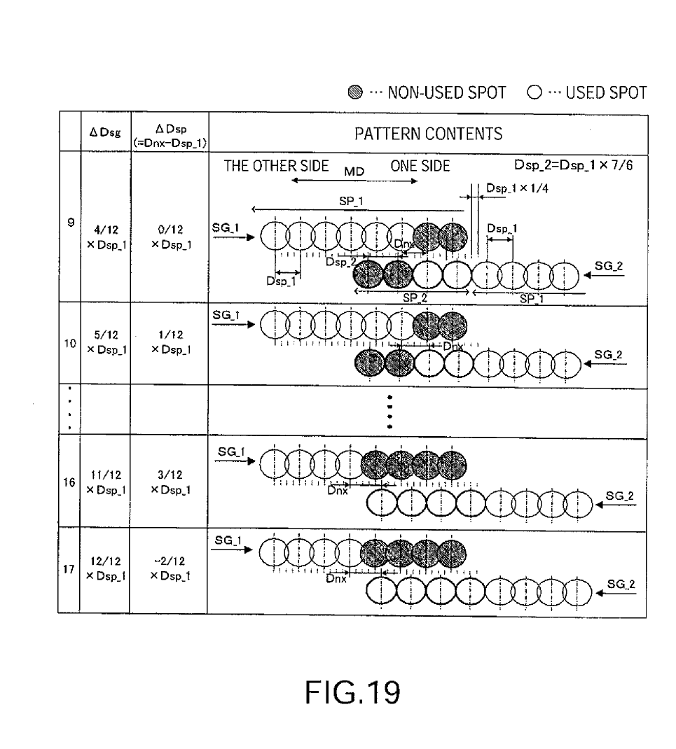

FIG. 18 and FIG. 19 show a chart indicating spots used in the latent image forming action, which show patterns used for each width Wol of the overlapped exposed area EX_ol. In this chart, the spots used in the latent image formation are indicated by hollow circles, and spots which are not used in the latent image formation are indicated by hatched circles. As shown in FIG. 17 and so on, the plurality of spots SP which constitute the spot group SG are arranged two-dimensionally. However, in FIG. 18 and FIG. 19, for easy understanding of the latent image forming action, the plurality of spots in the respective spot groups are arranged linearly in the primary scanning direction MD. The second spots SP_2 are indicated by circles with a thicker line than the first spots SP_1.

The chart will be described in sequence from the left side column. The leftmost column shows numbers assigned to the patterns of the spots used for each width Wol of the overlapped exposed area EX_ol in sequence. The column “ΔDsg” shows the difference between the spot group distance Dsg in a state of being free from the skew and the spot group distance Dsg in a state of being skewed (the group distance shift ΔDsg). When the shift occurs in the direction to reduce the spot group distance, the spot group distance Dsg takes a negative value, and when the shift occurs in the direction to increase the spot group distance, the spot group distance Dsg takes a positive value. The column “ΔDSp” shows the boundary spot center distance shift ΔDsp which indicates an extent of shift of the spot center distance (a boundary spot center distance Dnx) between the two spots SP which constitute the boundary spot pair with respect to the first spot center distance Dsp_1. The boundary spot center distance shift ΔDsp is given by the following expression:

ΔDsg=Dnx−Dsp_{—}1.

Here, the boundary spot pair are spots belonging to the spot groups SG different from each other, and is a pair including two spots SP formed adjacently in terms of the primary scanning direction MD in the actual latent image forming action. In other words, the boundary spot center distance shift ΔDsp is a distance between the two spots SP formed adjacently in terms of the primary scanning direction MD by the different spot groups SG, and if the boundary spot center distance shift ΔDsp is smaller, it is better for forming the satisfactory latent image. The column of “PATTERN CONTENTS” shows patterns of the spots to be used. In the column of “PATTERN CONTENTS”, the finest scale corresponds to ¼ the first spot center distance Dsp_1 (see the notation “Dsp_1×¼ in the same column).

In this chart, respective patterns 1 to 17 in the case where the group distance shift ΔDsg occurs from −4/12×Dsp_1 to 12/12×Dsp_1. In the pattern 1, five first spots SP_1 from one side of a first spot group SG_1 are not used for the group distance shift ΔDsg=−4/12×Dsp_1. Consequently, the boundary spot center distance shift ΔDsp is: ΔDsp=0/12×Dsp_1 (=0). In the pattern 2, four second spots SP_2 from the other side of a second spot group SG_2 are not formed for the group distance shift ΔDsg=−3/12×Dsp_1. Consequently, the boundary spot center distance shift ΔDsp is: ΔDsp=−3/12×Dsp_1. In the patterns 3 to 6, as in the pattern 2, the four second spots SP_2 from the other side of the second spot group SG_2 are not formed. Consequently, the boundary spot center distance shift ΔDsp is −2/12×Dsp_1 to 1/12×Dsp_1. In the patterns 7 and 8, the first spot Sp_1 at the end on one side of the first spot group SG_1 is not used, and three second spots SP_2 from the other side of the second spot group SG_2 are not used. Consequently, the boundary spot center distance shift ΔDsp is 0/12×Dsp_1 (=0) in the pattern 7 and is 1/12×Dsp_1 in the pattern 8. In the patterns 9 and 10, the two first spots SP_1 at the end on one side of the first spot group SG_1 is not used, and the two second spots SP_2 from the other side of the second spot group SG_2 are not used. Consequently, the boundary spot center distance shift ΔDsp is 0/12×Dsp_1 (=0) in the pattern 9 and is 1/12×Dsp_1 in the pattern 10. In the patterns 16 and 17, the four first spots SP_1 from the other side of the first spot group SG_1 are not used. Consequently, the boundary spot center distance shift ΔDsp is 3/12×Dsp_1 in the pattern 16 and is −2/12×Dsp_1 in the pattern 17. In this manner, by controlling the spots SP to be used for forming the latent image, the boundary spot center distance Dnx of the two spots SP which constitute the boundary spot pair is adjusted. Therefore, the absolute value of the boundary spot center distance shift ΔDsp can be reduced to a value smaller than ¼×Dsp_1, so that the formation of the satisfactory latent image is enabled.

As described above, in this embodiment, the plurality of image forming optical systems are provided and the each image forming optical system forms the spot group SG. Then, the two spot groups which are formed by the different image forming optical systems are overlapped to each other in the primary scanning direction MD (when viewed in the direction orthogonal to the primary scanning direction MD) to form the overlapped exposed area. Then, the spot group SG includes the plurality of first spots SP_1 arranged in the primary scanning direction MD at the first spot center distance Dsp_1 and the plurality of second spots SP_2 arranged in the primary scanning direction MD at the second spot center distance Dsp_2, and the first spot center distance Dsp_1 and the second spot center distance Dsp_2 are different from each other. In other words, in this embodiment, the image forming optical systems are able to form the spots SP at different spot center distances Dsp. In this manner, the realization of the satisfactory latent image formation is achieved.

In particular, in this embodiment, there are the plurality of first spots SP_1 formed at the first spot center distance Dsp_1 in the end portion on one side of the spot group SG in terms of the primary scanning direction MD, and the plurality of second spots SP_2 formed at the second spot center distance Dsp_2 in the end portion on the other side of the spot group SG in terms of the primary scanning direction MD. Therefore, as shown in FIG. 17, in the overlapped exposed area, the first spots SP_1 and SP_2 which are formed at the different spot center distances Dsp are overlapped with each other. Accordingly, the realization of the satisfactory latent image formation is achieved.

In other words, the head controller HC selects the light-emitting elements used for forming the latent image according to the extent of the overlap of the overlapped exposed area EX_ol. Consequently, as shown in FIG. 18 and FIG. 19, the boundary spot center distance Dnx between the two spots SP which constitute the boundary spot pair is adjusted, so that the absolute value of the boundary spot center distance shift ΔDsp can be reduced to a value smaller than ¼×Dsp_1, so that the formation of the satisfactory latent image is enabled.

The invention is specifically suitable for the configuration in which the image forming optical systems are arranged at different positions in terms of the widthwise direction LTD as in this embodiment. In other words, as shown in FIG. 13, in this configuration, the spot group distance Dsg in terms of the primary scanning direction MD might be varied due to the skew. In such a case, it is suitable to enable the formation of the satisfactory latent image by providing the overlapped exposed area and applying the invention.

In this manner, in this embodiment, the line head 29 corresponds to an “EXPOSURE HEAD” in the invention. The longitudinal direction LGD and the primary scanning direction MD correspond to a “FIRST DIRECTION” in the invention, and the widthwise direction LTD and the secondary scanning direction SD correspond to a “SECOND DIRECTION” in the invention. The lenses LS1 and LS2 function as the “IMAGE FORMING OPTICAL SYSTEMS” in the invention. Also, the spot SP corresponds to a “BEAM SPOT” in the invention, the spot group SG corresponds to a “GROUP OF BEAM SPOT” in the invention, the first spot center distance Dsp_1 corresponds to a “FIRST SPOT CENTER DISTANCE Dsp_1” in the invention, and the second spot center distance Dsp_2 corresponds to a “SECOND SPOT CENTER DISTANCE Dsp_2” in the invention. Also, the video data VD corresponds to an “IMAGE SIGNAL” in the invention.

The invention is not limited to the embodiment described above, and various modifications may be made without departing the scope of the invention in addition to the configuration described above. For example, in the embodiment described above, the first spot center distance Dsp_1 and the second spot center distance Dsp_2 satisfy the following expression:

Dsp_{—}2=Dsp_{—}1×7/6.

However, to satisfy the relation as described above between the first spot center distance Dsp_1 and the second spot center distance Dsp_2 is not essential in the invention, and what is essential is to differentiate between the first spot center distance Dsp_1 and the second spot center distance Dsp_2.

It is also applicable to configure such that the first spot center distance Dsp_1 and the second spot center distance Dsp_2 satisfy one of the following inequalities:

1.0×Dsp_{—}2<Dsp_{—}1<1.5×Dsp_{—}2, and

0.5×Dsp_{—}2<Dsp_{—}1<1.0×Dsp_{—}2.

In this configuration, the absolute value of the boundary spot center distance shift ΔDsp can be reduced to a value smaller than ½×Dsp_1.

Alternatively, it is also applicable to configure such that the first spot center distance Dsp_1 and the second spot center distance Dsp_2 satisfy one of the following inequalities:

1.0×Dsp_{—}2<Dsp_{—}1<1.25×Dsp_{—}2, and

0.75×Dsp_{—}2<Dsp_{—}1<1.0×Dsp_{—}2.

In this configuration, the absolute value of the boundary spot center distance shift ΔDsp can be reduced to a value smaller than ¼×Dsp_1.

In the embodiment described above, the spots SP other than those in the overlapped exposed area EX_ol are arranged at the first spot center distance Dsp_1. However, to arrange the spots SP other than those in the overlapped exposed area EX_ol at the first spot center distance Dsp_1 is not essential, and they may be arranged at the spot center distance Dsp different from the first spot center distance Dsp_1.

Also, in the embodiment described above, all spots SP in the second spot group SG in the overlapped exposed area EX_ol are the second spots SP_2 arranged at the second spot center distance Dsp_2. However, a configuration in which part of the spots SP in the second spot group SG in the overlapped exposed area EX_ol are the second spots SP_2, while other spots SP are the first spots SP_1 may also be applicable.

Also, in the embodiment described above, the skew is exemplified as a cause of occurrence of the gap between the adjacent spot groups SG. However, the cause of occurrence of such a gap is not limited to the skew. For example, when the lens array is configured as an embodiment described below, the gap might be generated due to other reasons. This will be described below.

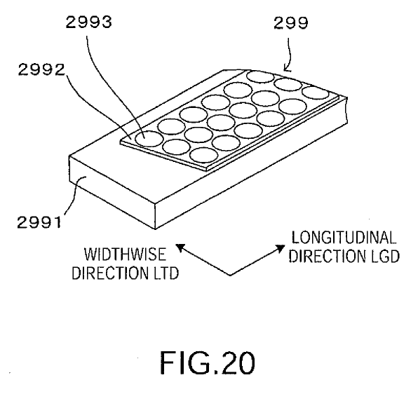

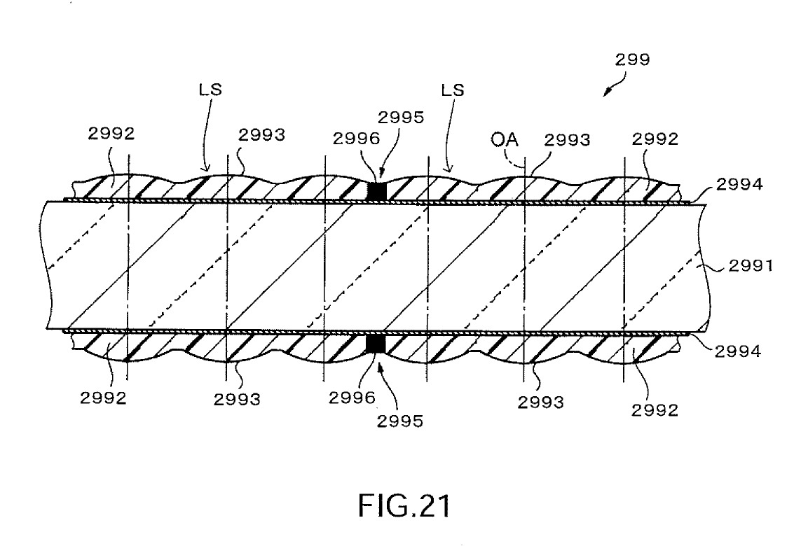

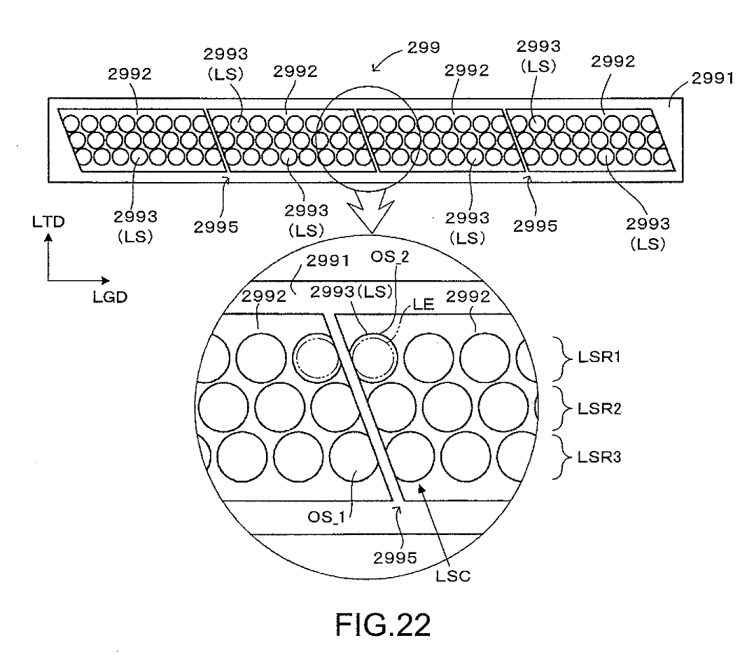

FIG. 20 is a schematic partial perspective view of a lens array according to another embodiment. FIG. 21 is a longitudinal partial cross-sectional view of the lens array according to the another embodiment. FIG. 22 is a plan view of the lens array according to the another embodiment. In FIG. 20 and FIG. 21, the lens array 299 includes a glass substrate 2991 as a transparent substrate and a plurality of (eight in this embodiment) plastic lens substrate 2992. Since these drawings are partial drawings, all components are not shown.

In FIG. 20 and FIG. 21, the plastic lens substrates 2992 are provided on both sides of the glass substrate 2991. In other words, as shown in FIG. 22, on one surface of the glass substrate 2991, the four plastic lens substrates 2992 are combined linearly and are bonded by an adhesive agent 2994. The shape of the lens array 299 in plan view is a rectangular shape. In contrast, the shape of the plastic lens substrates 2992 is a parallelogram, and gap portions 2995 are formed between the four plastic lens substrates 2992. As shown in FIG. 21 and FIG. 22, the gap portion 2995 may be filled with a light-absorbing agent 2996, and as the light-absorbing agent 2996, a wide range of materials having characteristics which absorb light beams emitted from the light-emitting elements 2951 may be used. For example, resin including carbon fine particles may be employed. Shown in a circle in FIG. 22 is an enlarged view of a portion near the gap portion 2995.

Lenses 2993 are arranged so as to form three lens rows LSR1 to LSR3 in the longitudinal direction LGD of the lens array 299. The respective rows are arranged so as to be shifted slightly in the longitudinal direction LGD, and the lens columns LSC are arranged obliquely with respect to the short side of the rectangle when viewing the lens array 299 in plan view. The gap portions 2995 are formed between the lens columns LSC along the lens column LSC. Here, the lens column LSC includes three lenses LS arranged obliquely with respect to the short side of the rectangle.

The respective gap portions 2995 are formed so as not to be overlapped with effective ranges LE of the lenses 2993. The effective range LE of the lens means an area through which the light beams emitted from the light-emitting element group 295 pass. As a method of forming the gap portions 2995 so as not to be overlapped with the effective ranges LE of the lenses, there are a method of molding the plastic lens substrate in such a manner that end surfaces which define the gap portions 2995 are not overlapped with the effective ranges LE of the lenses in advance, and a method of molding a plurality of the plastic lens substrates integrally, and then cutting the same so as not to be overlapped with the effective ranges LE of the lenses.

On the other surface as well, the four plastic lens substrates 2992 are bonded with the adhesive agent 2994 corresponding to the four lens substrates 2992 described above. In this manner, the two lenses 2993 arranged in one-to-one correspondence so as to interpose the glass substrates 2991 constitute a biconvex lens as the image forming lens. The plastic lens substrates 2992 and the lenses 2993 may be molded integrally by injection molding of resin using a die.

The respective pairs of two lenses 2993 which constitute the image forming lenses have optical axes OA common to each other as shown by alternate long and short dashes lines in the drawing. The plurality of lenses are arranged in one-to-one correspondence in the plurality of light-emitting element groups 295 shown in FIG. 6. In this line head 29, only one piece of the lens array 299 configured in this manner is provided and, the image forming optical systems are formed by two each lenses 2993 and 2993 arranged in the direction of the optical axis OA in FIG. 21. The lens array 299 is configured so that the image forming optical system is arranged for each light-emitting element group 295.

When the gap portions 2995 are provided as described above, that is, when the plurality of lens substrates 2992 are combined to form the lens array 299, it is difficult to combine the lens substrates 2992 as designed, and a relative positional displacement might occur between the lenses LS arranged with the intermediary of the gap portions 2995. Then, as a result of this positional displacement, the two image forming optical systems which are formed on the different lens substrates 2992 and form spot groups SG adjacent in the primary scanning direction MD (for example, image forming optical systems OS_1 and OS_2 in FIG. 22) might form the spot groups SG with the intermediary of a gap. Therefore, it is recommended to configure in such a manner that the image forming optical systems OS_1 and OS_2 form the spot groups SG in an overlapped manner, and the spots SP are arranged at two spot center distances Dsp of the first spot center distance Dsp_1 and the second spot center distance Dsp_2 in the spot groups SG formed respectively by the image forming optical systems OS_1 and OS_2. Accordingly, the realization of the satisfactory latent image formation is achieved.

Also, in the embodiment described above, the light-emitting elements 2951 have a circular shape. However, the shape of the light-emitting elements is not limited thereto, and may be a rectangular shape or an oval shape. In any shapes, the positions of the light-emitting elements 2951 are obtained as centers of gravity of the light-emitting elements 2951 in plan view.

The number of the light-emitting elements 2951 in the light-emitting element group 295 or the number of the light-emitting element rows 2951R may also be changed as needed. Also, the number of the light-emitting elements 2951 which constitute the light-emitting element rows 2951R may also be changed as needed.

Furthermore, the number of the light-emitting element group rows 295R or of the lens rows LSR may be changed as needed.

Also, in the embodiment described above, bottom-emission type organic EL elements are used as the light-emitting elements 2951. However, top-emission type organic EL elements may be used as the light-emitting elements 2951, or LED (Light Emitting Diode) may be used as the light-emitting elements 2951.

In the embodiment described above, the image forming optical systems having an inverting optical characteristic are used. However, the image forming optical systems are not limited thereto, and those having an orthogonal optical characteristic may be used. As regards the magnifications of the image forming optical systems, any one of scaling-up and scaling-down may be employed.

In the embodiment described above, in the light-emitting element group 295, the spots SP are formed at the first spot center distance Dsp_1 and the second spot center distance Dsp_2 in the spot group SG by arranging the light-emitting elements 2951 at the first light-emitting element center distance Del_1 and the second light-emitting element center distance Del_2. However, even when the light-emitting element center distance Del is constant in the light-emitting element group 295, the spots SP may be formed at the first spot center distance Dsp_1 and the second spot center distance Dsp_2 in the spot group SG by adjusting the optical characteristics of the image forming optical system. This will be described below.

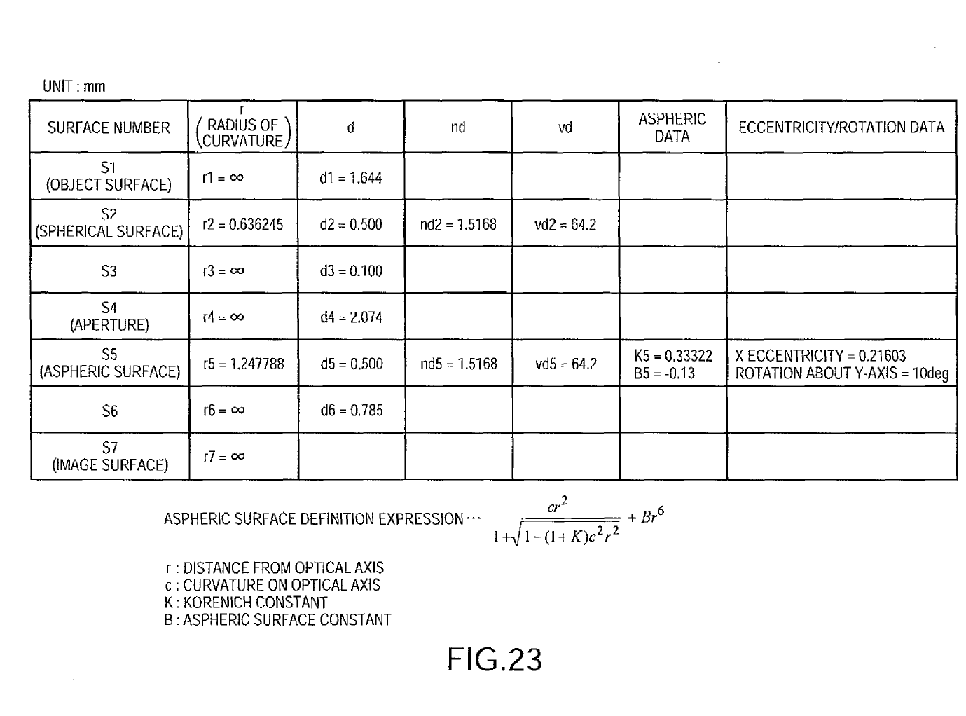

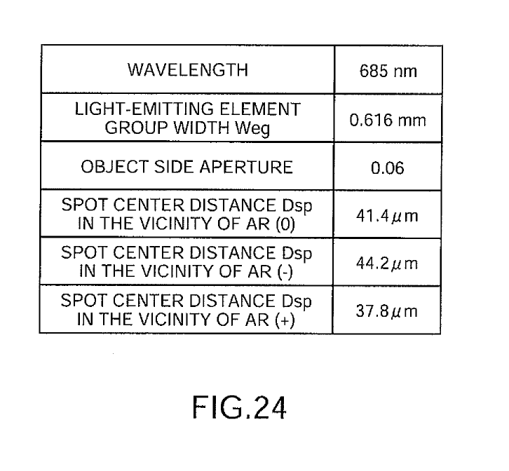

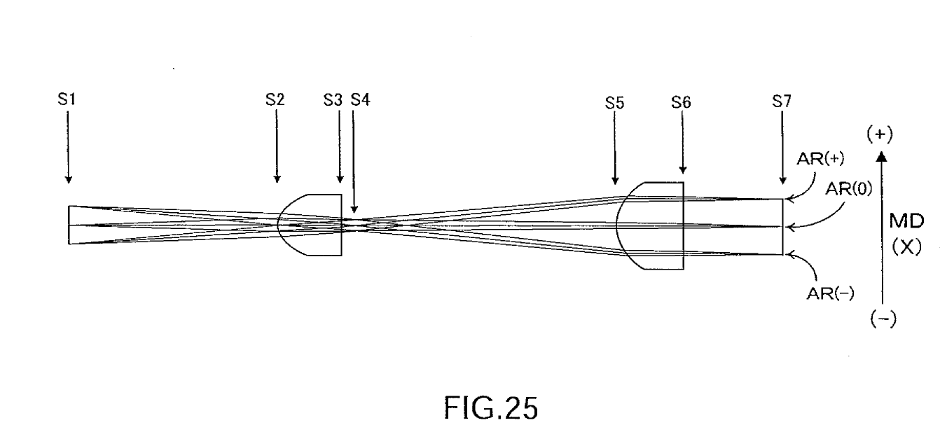

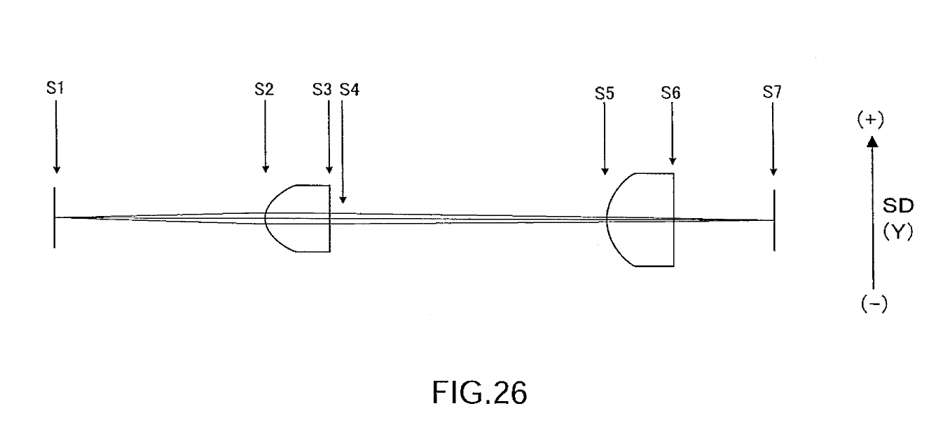

FIG. 23 is a drawing showing lens data of still another embodiment. FIG. 24 is a drawing showing optical data of the still another embodiment. FIG. 25 is a cross-sectional view of the optical system in the primary scanning direction according to the still another embodiment, and FIG. 26 is a cross-sectional view of the optical system in the secondary scanning direction according to the still another embodiment. FIG. 25 and FIG. 26 also show the optical paths in cross section respectively. In these drawings, the X-axis corresponds to the primary scanning direction MD, and the Y-axis corresponds to the secondary scanning direction SD.

In the light-emitting element group 295, the plurality of light-emitting elements 2951 are arranged at a constant light-emitting element center distance Del (=28 μm) in the primary scanning direction MD. In contrast, in the spot group SG, the spot center distances Dsp are different depending on the position in the primary scanning direction MD. In other words, as shown in FIG. 24 and FIG. 25, the spot center distance Dsp is 44.2 μM in an area AR(−) in the vicinity of the end portion of the spot group SG on the minus side in the X-axis direction, the spot center distance Dsp is 41.4 μm in an area AR(0) in the vicinity of the optical axis of the spot group SG, and the spot center distance Dsp is 37.8 μm in an area AR (+) in the vicinity of the end portion of the spot group SG on the plus side in the X-axis direction. In this manner, in the still another embodiment as well, the spot center distance in the end portion on one side and the spot center distance in the end portion on the other side in the primary scanning direction MD are different from each other.

What is claimed is:

1. An image forming apparatus comprising:
a latent image carrier; and
an exposure head having light-emitting elements configured to emit light beams, and an image forming optical system configured to form a group of beam spots on the latent image carrier with the light beams emitted from the light-emitting elements,
wherein the different image forming optical systems form the groups of beam spots in an overlapped manner in a first direction, and the light-emitting elements include the light-emitting elements which define a first spot center distance Dsp_1 in the first direction and the light-emitting elements which define a second spot center distance Dsp_2 different from the first spot center distance in the first direction.

2. The image forming apparatus according to claim 1, wherein the light-emitting elements formed at the first spot center distance Dsp_1 are formed at a first end portion in the first direction of the group of beam spots, and the light-emitting elements formed at the second spot center distance Dsp_2 are formed at a second end portion on the opposite side in the first direction of the group of beam spots.

3. The image forming apparatus according to claim 1, comprising: a control unit configured to select the light-emitting elements so that the light-emitting elements are turned on according to image signals to form the beam spots on the latent image carrier.

4. The image forming apparatus according to claim 3, wherein the first spot center distance Dsp_1 and the second spot center distance Dsp_2 satisfy one of the relations:
1.0×Dsp_{—}2<Dsp_{—}1<1.5×Dsp_{—}2 and
0.5×Dsp_{—}2<Dsp_{—}1<1.0×Dsp_{—}2.

5. The image forming apparatus according to claim 3, wherein the first spot center distance Dsp_1 and the second spot center distance Dsp_2 satisfy one of the relations:
1.0×Dsp_{—}2<Dsp_{—}1<1.25×Dsp_{—}2 and
0.75×Dsp_{—}2<Dsp_{—}1<1.0×Dsp_{—}2.

6. The image forming apparatus according to claim 1, wherein the image forming optical systems may be arranged in a second direction orthogonal or substantially orthogonal to the first direction.

7. An image forming method comprising:
forming a latent image on a latent image carrier by an exposure head having light-emitting elements configured to emit light beams and form beam spots on the latent image carrier and image forming optical systems configured to form images of the light beams emitted from the light-emitting elements arranged in a first direction and form group of beam spots on the latent image carrier,
wherein the different image forming optical systems form the group of beam spots in an overlapped manner in the first direction, and the light-emitting elements include the light-emitting elements which are arranged at a first spot center distance Dsp_1 in the first direction of the group of beam spots and the light-emitting elements which are arranged at a second spot center distance Dsp_2 different from the first spot center distance in the first direction of the group of beam spots.
